(19) United States
(12) Patent Application Publication
(10) Pub. No.: US 2025/0177849 A1
(43) Pub. Date: Jun. 5, 2025

(54) MODULAR FABRIC-UNIT FOR THE CONSTRUCTION OF GAME BOARDS

(71) Applicant: Ross Charles Halgren, Collaroy Plateau (AU)

(72) Inventor: Ross Charles Halgren, Collaroy Plateau (AU)

(21) Appl. No.: 19/053,457

(22) Filed: Feb. 14, 2025

(30) Foreign Application Priority Data
Feb. 15, 2024 (AU) 2024900365

(51) Int. Cl. A63F 3/00

(52) U.S. Cl. CPC A63F 3/00261; A63F 3/00214; A63F 2003/00381; A63F 2003/00388

(57) ABSTRACT

The present invention provides a modular “fabric-unit” with preferred embodiments for the construction of a multitude of different self-supporting game boards of different types, sizes and shapes, wherein the fabric-unit comprises an array of 3-dimensional square “fabric-cells” for game tiles or 3D game pieces and game board accessories, mounting slots in the form of cross-connectors for attaching game board accessories and a background graphic layer, a plurality of hermaphroditic edge connectors on all sides of the fabric-unit, whereby the hermaphroditic edge connectors make a strong connection with hermaphroditic edge connectors of an adjacent inverted fabric-unit of the same construction, and the fabric-unit comprising small profile crossbars and walls and preferably high optical transparency material to increase visibility of a background graphic layer, and matching edge-panels for providing a cosmetic perimeter to the game board and for attaching a background graphic layer.

### RELATED APPLICATIONS

IP Australia

Provision Patent Application number: 2024900365 filed 15 Feb. 2024.
Invention Title: Generic Game Board Fabric
Inventor: Halgren, Ross
Agent Name: Haltec Enterprises Pty Ltd

### PRIOR ART

### PATENTS

WO 2023/275868 A1 (Cubartis Games) 28 Jun. 2022,

U.S. Pat. No. 5,048,840A (Albert L. Johnson, Jr) 17 Sep. 1991

### Non-Patent Literature

Carcassonne Grids

Dragonlock Tiles

OpenLock™ Magnetic Base System

Dry Erase Modular Translucent Acrylic RPG Board

### FIELD

The present invention relates to the mechanical construction of game boards using modular and interlocking grids, tiles and tile holders.

### BACKGROUND

Dedicated game boards and modular game boards are available for traditional board games such as Chess and Checkers, tile playing games such as Carcassonne, and Role-Playing Games (RPGs) such as Hero Quest and Dungeons & Dragons.

The prior art for dedicated game boards is that they generally comprise an entire game board which is “self-supporting” and thus may be picked up and moved between tables or stored elsewhere for continuing the game later. The game pieces may be moved with the game board, but unless the game board is metallic and the game pieces have magnetic bases, the game pieces tend to slide around and could end up on a different game square or circle. Para [0002] references an example patent for such a game board. Refer WO 2023/275868 A1 Drawing 1/51 FIG. 1.

As illustrated in FIG. 1, the prior art for modular game boards requires their assembly module by module on a tabletop. As per prior art game board module types referenced in paras [0004], [0005], [0006] and [0007], a module may comprise a single tile (401) or a group of tiles (301) for placing game pieces with optional slots (305) for connecting game accessories, or a 3D printed plastic grid (201) for holding an array of tiles (204) each tile comprising part of a background graphic (207), whereby the connection of each module often uses a jigsaw type of male (203, 303) and female (202, 302) edge connectors, or clips (404) that connect adjacent modules, or magnetic balls (414) located on each side of a module that freely rotate within a spherical enclosure (412) to align and magnetically hold adjacent modules together. A common feature of all these module connection arrangements is that they don't have the strength to game board weight ratio for the game board to be self-supporting. Like any jigsaw puzzle assembled on a tabletop, some module connections will break when attempting to move the assembled game board.

The prior art reference in para [0003] is an example patent for a modular three-dimensional stacking game board that may be divided into a plurality of sections, all of which can be built upon with stacking pieces and top pieces. A specific hermaphroditic-like connector arrangement is described for connecting the vertical stacking pieces to each other and to each section of the gameboard. The sections may then be placed together side by side to form a complete gameboard. However, in contrast to the present invention, there are no edge connectors for binding adjacent sections together. Instead, the gameboard comprises multiple disconnected sections that are butted together and placed in a suitably sized tray for preventing movement of the sections and for carrying, storing or packaging purposes. As such, the gameboard sections are not self-supporting and their vertical hermaphroditic connector arrangement is completely different to that described for the present invention.

3D Printers have enabled greater flexibility for game board design and construction, with free and purchasable 3D printed tiles that butt together or connect to form game boards of any size or shape with such tiles including optional 3D printed walls and other game accessories. Game pieces and accessories can similarly be 3D printed or may be purchased off-the-shelf, already manufactured by various means. More sophisticated 3D printed RPG game board designs such as Dungeons and Dragons are available as a complete system comprising buildings, walls and squares for 3D game pieces to occupy but once printed and painted, are fixed in their design. There is little flexibility to change their design to support different games and game board types.

For tile playing games such as Carcassonne, grids (201) are designed to hold tiles with their own background graphic printed (207) onto each tile and do not attempt to minimise the surface area of the underlying plastic material (206) to maximise the visibility of an alternative printed background graphic that could be installed under the grid. Optically transparent 3D print materials are generally not as transparent as they claim, so options are limited for the hobbyist to 3D print a game board and place a game-specific printed background graphic underneath the 3D printed board whereby the background graphic has maximally unobstructed visibility. Many 3D printed tile holders, tiles and complete 3D printed game board systems are also time-consuming and expensive to 3D print compared to alternative injection moulded products.

### SUMMARY

The present invention enables the construction of “self-supporting” game boards of various types, sizes and shapes using the modular design approach, wherein each module called a “fabric-unit” comprises an array of square “fabric-cells” for placing game tiles or 3D game pieces, female “cross-connectors” in the walls between said fabric-cells for attaching game board accessories for role playing games such as Dungeons & Dragons, a highly visible background graphic layer defined by or for the game being played that plugs into the underside of said female cross-connectors, and a perimeter of “edge connectors” with one edge connector per outer fabric-cell for connecting adjacent fabric-units and cosmetic edge panels. The objective of constructing a self-supporting game board is uniquely supported by a critical element of the present invention being low-profile “hermaphroditic” edge connectors (HECs) comprising a lip and channel structure having high binding strength when two adjacent fabric-units are inverted with respect to each other and then connected. For the same length, width and height dimensions, the said hermaphroditic edge connectors have typically three times the binding surface area and hence higher binding strength compared to representative low profile jigsaw type edge connectors as used by Carcassonne tile holders for example.

### BRIEF DESCRIPTION OF THE DRAWINGS

A detailed description of preferred embodiments will follow, by way of example only, with reference to the accompanying figures of the drawings, in which:

FIG. 1 shows examples of the prior art for game board modules, where:

FIG. 1A shows the joining of two 3×3 tile holders having jig-saw type edge connectors.

FIG. 1B shows a tile comprising 4 game cells and slots for game accessories and jig-saw style edge connectors.

FIG. 1C shows the connection of tiles for a Dungeons and Dragons RPG using Dragonbite clips for holding adjacent tiles together or optional add-on bases with magnetic ball type edge connectors.

FIG. 2 shows the top side, plan and isometric views of a fabric-unit comprising 16 fabric-cells.

FIG. 3A shows in more detail, the top side (T), plan view of fabric-unit Example 1 comprising 16 fabric-cells.

FIG. 3B shows in more detail, the bottom side (B), plan view of a fabric-unit Example 1 comprising 16 fabric-cells.

FIG. 4A shows in more detail, the top side (T) plan view of fabric-unit Example 2 comprising 16 fabric-cells.

FIG. 4B shows in more detail, the bottom side (B), plan view of a fabric-unit Example 2 comprising 16 fabric-cells.

FIG. 5A is an isometric view of a fabric-unit hermaphroditic edge connector (HEC) Example 2 facing up.

FIG. 5B is an plan view of a fabric-unit with a hermaphroditic edge connector Example 2 facing up.

FIG. 6A is a side view of a fabric-unit and a hermaphroditic edge connector Example 1 facing up.

FIG. 6B is a side view of a fabric-unit and a hermaphroditic edge connector Example 2 facing up.

FIG. 7 shows profile views of cell walls (crossbar and outer cell wall) and the lip of a hermaphroditic edge connector all constructed with a draft angle (A°).

FIG. 8A is side view of two adjacent fabric-units about to be joined by their hermaphroditic edge connectors.

FIG. 8B is side view of two adjacent fabric-units that have been joined by their hermaphroditic edge connectors.

FIG. 9 is a isometric view of two adjacent fabric-units that have been joined by hermaphroditic edge connectors Example 2, showing female and male cross-connectors.

FIG. 10 shows a plan view of 4 fabric-units Example 1 connected to make a 64 fabric-cell game board.

FIG. 11 shows a plan view of 4 fabric-units Example 2 connected to make a 64 fabric-cell game board.

FIG. 12 shows the addition of 2 types of straight (30 & 50) and 2 types of corner (40 & 60) tapered edge panels to a 64 fabric-cell game board containing fabric-units Example 1.

FIG. 13A shows details of a tapered straight edge panel with edge connectors up (30) and with optional female button-hole connectors and compatible male button connectors.

FIG. 13B shows details of female button-hole connectors and compatible male button connectors.

FIG. 13C shows details of a tapered corner edge panel with edge connectors up (40) and with optional female button-hole connectors and compatible male button connectors.

FIG. 14A shows details of a tapered straight edge panel with edge connectors down (50) and with optional female button-hole connectors and compatible male button connectors.

FIG. 14B shows details of a tapered corner edge panel with edge connectors down (60) and with optional female button-hole connectors and compatible male button connectors.

FIG. 15A shows the plan view of symmetrical straight (62) and corner edge panels (63) with edge connectors up and their connection to a fabric-unit Example 2.

FIG. 15B shows symmetrical straight and corner edge panels in isometric view.

FIG. 15C shows a side (profile) view of a symmetrical edge connector.

FIG. 16 shows the circular indenting of fabric-cells to better support square and slightly larger circular 3D game piece bases.

FIG. 17 illustrates a 384 fabric-cell game board containing 24 fabric-units manufactured using the preferred injection moulding of a material having high optical transparency.

FIG. 18 shows the assembly of a background graphic layer to a 24 fabric-unit game board.

FIG. 18A illustrates the top side of a bare 24 fabric-unit game board with tapered edge panels.

FIG. 18B illustrates a background graphic layer with male cross-connectors (17A) and button connectors (31L) affixed to the background graphic layer for its attachment to the fabric-units.

FIG. 18C illustrates the underside of the bare 24 fabric-unit game board showing the female cross-connectors (8L) and buttonhole connectors (32E) to which the compatible male cross-connectors and button connectors will be attached.

FIG. 18D illustrates the top side of the assembled game board and background graphic layer.

FIG. 19 shows a section of a fabric-unit game board with a 3D game piece and game accessories such as 3D buildings and walls attached using compatible male cross-connectors.

FIG. 20 shows female buttonholes and male buttons, the latter comprising a removeable wax paper or plastic cover over a glue layer for affixing to a background graphic layer.

FIG. 21 illustrates an array of compatible male cross-connectors manufactured using the injection moulding method.

FIG. 22 defines the length dimensions for a square fabric-unit Example 1 with 16 fabric-cells.

FIG. 23 defines the width dimensions for a square fabric-unit Example 1 with 16 fabric-cells.

FIG. 24 shows fabric-unit Example 1 hermaphroditic edge connectors 3T1, 3T2, 3T3 & 3T4 and defines length and width dimensions in side view.

FIG. 25A defines hermaphroditic edge connector 3T1 Example 1 length and height dimensions in side view.

FIG. 25B defines hermaphroditic edge connector 3T1 Example 2 length and height dimensions in side view.

FIG. 26 defines female buttonhole and male button diameter and thickness dimensions.

FIG. 27 defines tapered straight edge-panel dimensions for both connector up and down types.

FIG. 28 defines tapered corner edge-panel dimensions for both connector up and down types.

FIG. 29 defines circular and square game piece base dimensions.

FIG. 30 defines male cross-connector dimensions to be compatible with a female cross-connector and defines representative dimensions of a cross-connector array for injection moulding and for fitting to a female cross-connector array,

FIG. 31 defines the length dimensions for a square fabric-unit Example 2 with 16 fabric-cells.

FIG. 32 defines the width dimensions for a square fabric-unit Example 2 with 16 fabric-cells.

FIG. 33 defines the cross-sectional profile length (or width), height and draft angle dimensions for fabric-cell walls (crossbar and outer cell wall), and for the lip of a hermaphroditic edge connector (not to scale).

FIG. 34 shows length, width and height dimensions in more detail and defines rounded corner diameter dimensions (D6) for a hermaphroditic edge connector Example 2.

FIG. 35 shows fabric-unit Example 2 hermaphroditic edge connectors (4 per side) and half female cross-connectors (8E) (3 per side) and defines the HEC length, width and height dimensions in side view.

FIG. 36 defines length, width and height dimensions for symmetrical edge panels (62 & 63).

FIG. 37 is a table of dimensions and representative values for 120 mm square fabric-units Example 1 and Example 2. Values are listed against the length, width, height, diameter and angle dimensions defined in FIGS. 22-36.

FIG. 38 is a table of dimensions and representative values for edge panels, game piece bases and accessories such as compatible male cross-connectors for use with 120 mm square fabric-units Example 1 and Example 2. Values are listed against the length, width, height, diameter and angle dimensions defined in FIGS. 22-36.

FIG. 39 is a non-exhaustive list of Dimensional Relationships (DR) between various length, width and height parameters for fabric-units having Example 1 and Example 2 embodiments.

FIG. 40 compares the Contact Surface Area (CSA) of male and female jigsaw type edge connectors when joined and a pair of non-inverted and inverted hermaphroditic edge connectors Example 1 when joined.

### DETAILED DESCRIPTION

Throughout this detailed description and associated drawings, there are some naming conventions. In the drawings, there is one sheet per page and one figure number “FIG. N” per sheet which in some cases may be split into multiple figures FIG. NA, FIG. NB, FIG. NC etc on the same sheet. Reference in the text to all figures in a sheet may simply state FIG. N.

Numbered object reference labels (M) that have multiple views or instances of the same object may have label-suffixes (MA, MC, MD) etc with the restriction that the suffixes T, B, L, W and H are reserved exclusively for Top, Bottom, Length, Width and Height respectively. Reference to a figure and associated label may take the form (FIG. N-M).

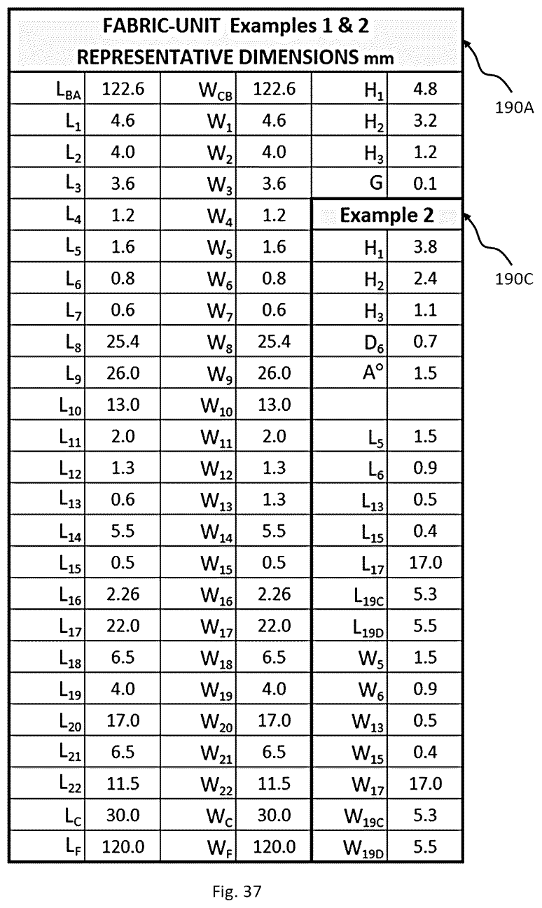

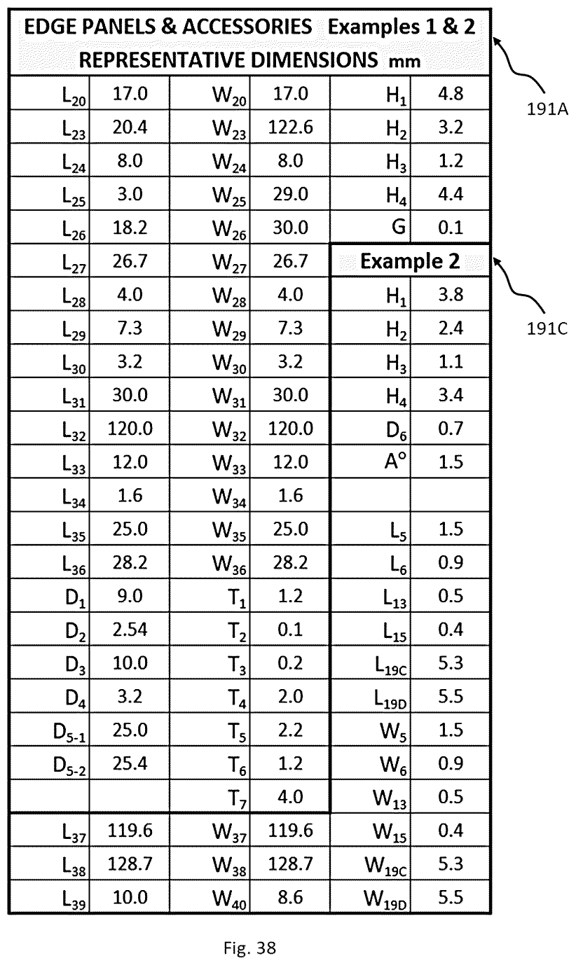

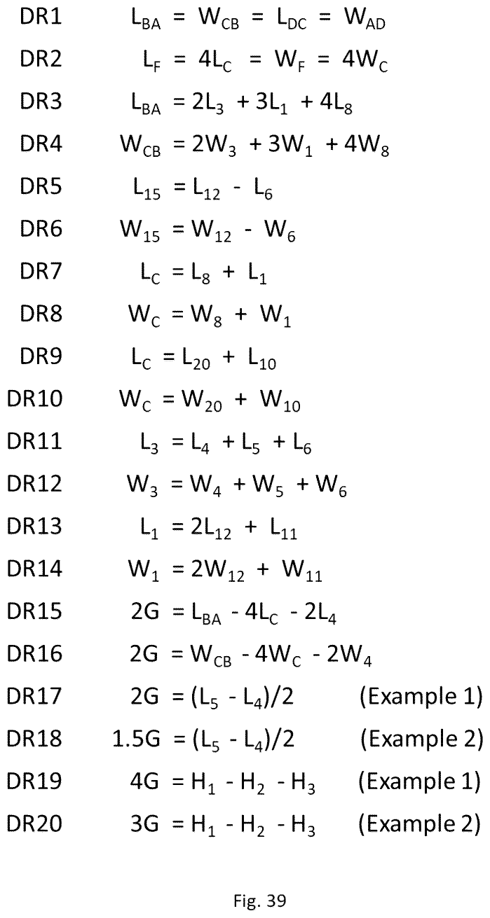

In the drawings, reference labels point to respective objects using squiggly arrows. The dimensions of objects and various parameters are specified using straight arrows with single or double arrowheads and a dimensional label Ln, Wn, Hn, Tn, Dn, kG and A, where L=Length, W=Width, H=Height, T=Thickness, D=Diameter, kG=Gap, A=Angle and “n” is a unique dimension for an object (e.g., fabric-cell wall) or parameter (e.g., fabric-cell spacing). FIG. 37 and FIG. 38 are tables containing a list of dimensional labels and representative values for preceding figures and for nominal 120 mm fabric-units with Example 1 and Example 2 embodiments. FIG. 39 contains a list of Dimensional Relationships (DR) that define the preferred embodiments of the present invention.

The present invention is first described in terms of its embodiments by referencing applicable drawings. Then, each drawing sheet is described sequentially to complete the detailed descriptions of all parts and features. Finally, the dimensions and dimensional relationships of preferred fabric-unit embodiments, edge panels and game piece bases are defined and representative values assigned.

### OVERVIEW OF THE EMBODIMENTS

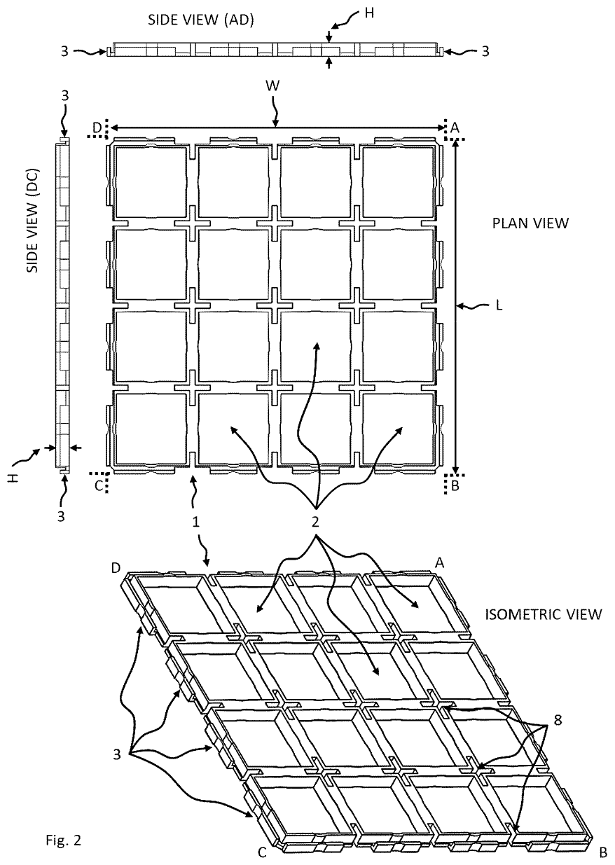

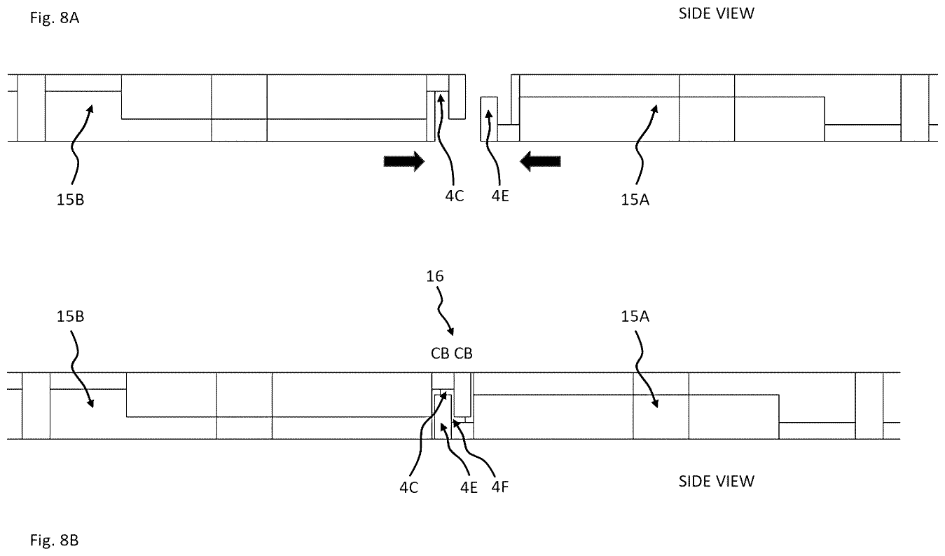

The present invention meets a 1^{st} objective of enabling the construction of self-supporting games boards of various types, sizes and shapes using the modular design approach wherein a strong and low-profile connection between game board modules called fabric-units (FIG. 2—1) is implemented using hermaphroditic edge connectors (HECs) (FIG. 2—3) that require adjacent fabric-units of the same design to be inverted with respect to each other to make the connections (FIG. 8). This is a critical element of the present invention.

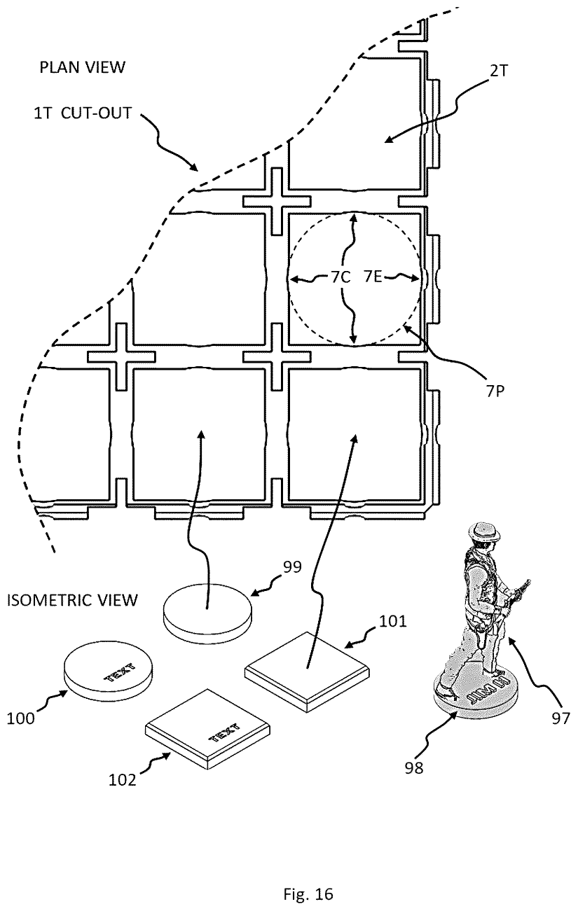

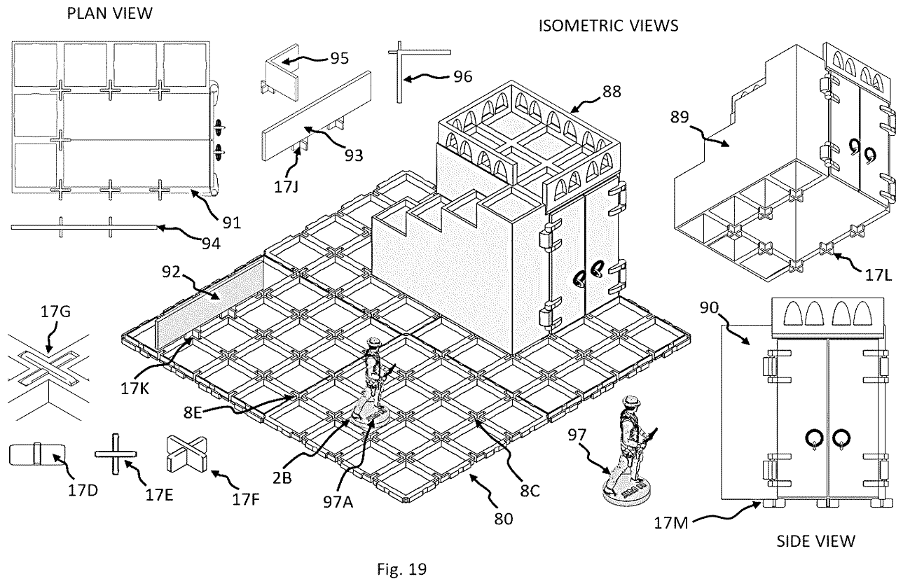

As illustrated in FIG. 2, the fabric-units comprise an array of equally dimensioned square 3D fabric-cells (2) for placing game tiles or 3D game pieces with typically square or circular bases (FIG. 16). The fabric-cells may alternatively be occupied by game board accessories such as 3D buildings (FIG. 19).

The preferred embodiment of the fabric-unit is square in shape and comprises 16 fabric-cells in a 4×4 array and 16 HECs for constructing traditional game boards such as Chess, for ease of 3D printing and volume manufacturing, and for providing a manageable number of fabric-units for constructing Role-Playing Game (RPG) boards such as Dungeons and Dragons.

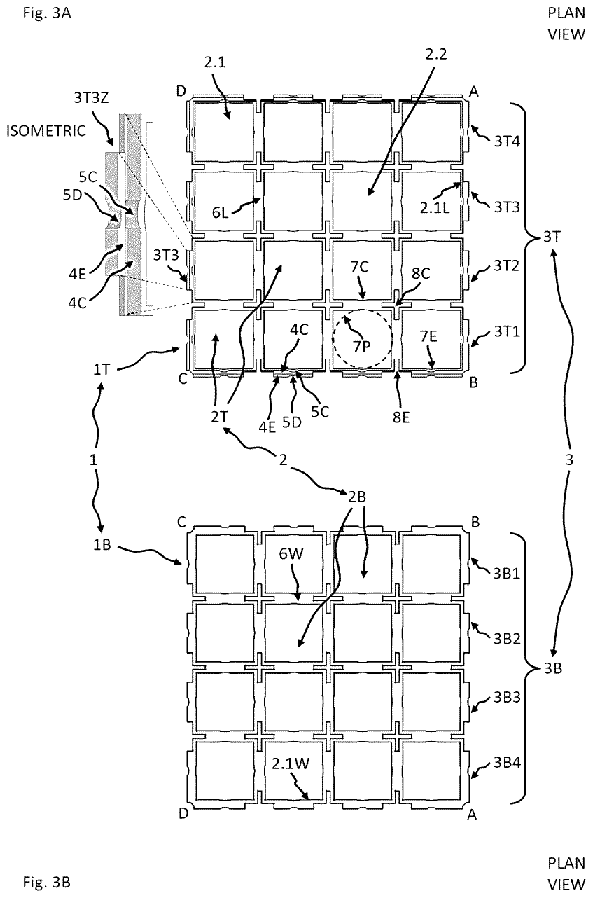

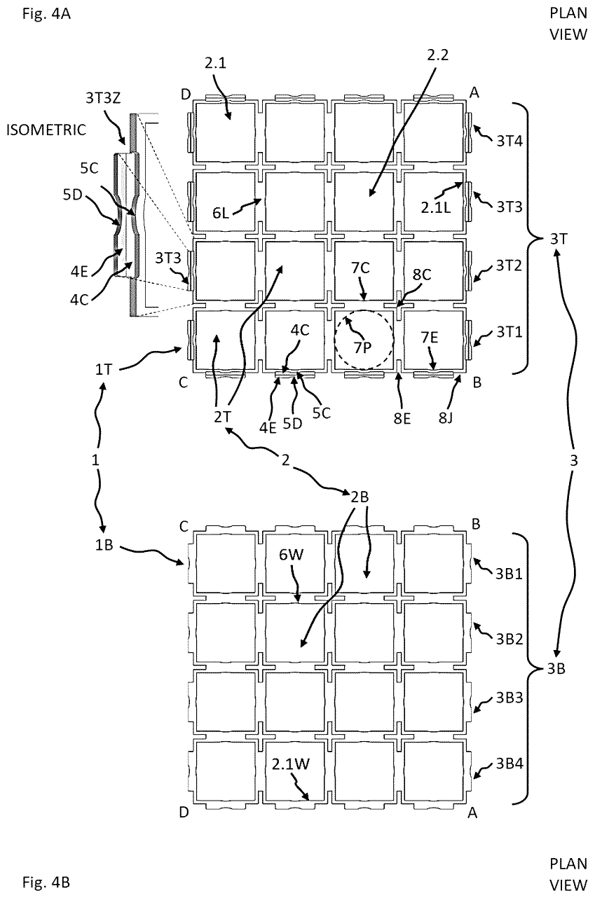

FIG. 3 and FIG. 4 illustrate two fabric-unit Examples 1 & 2 respectively, being preferred embodiments that follow the same design principles. Examples 1 & 2 comprise slight differences in their HEC design and layout that trade-off fabric-unit connection strength for other preferred features. To be described in detail, Examples 1 & 2 support other preferred embodiments to a lesser and larger extent and different preferred manufacturing methods, such as 3D printed, and plastic injection moulded respectively. FIGS. 3A and 4A are plan views of the top side (T) of the Example 1 & 2 fabric-units. FIGS. 3B and 4B are plan views of the bottom side (B) of the Example 1 & 2 fabric-units.

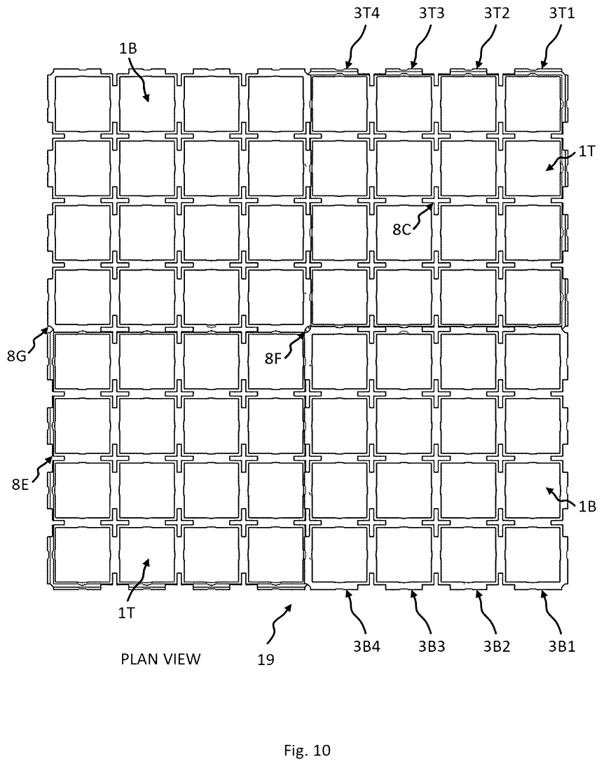

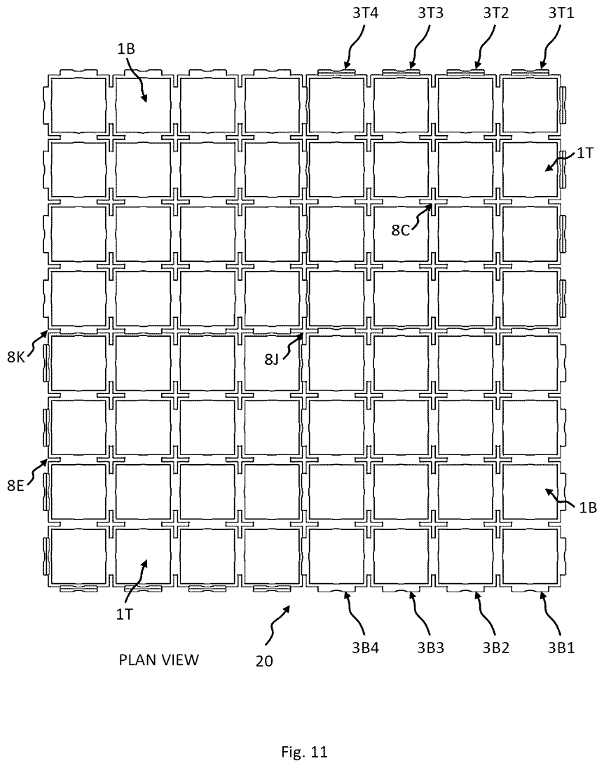

FIG. 10 and FIG. 11 illustrate the 64 squares of a Chess board constructed using four interconnected fabric-units, each comprising the preferred 4×4 array of fabric-cells. FIG. 10 uses the Example 1 fabric-unit embodiment and FIG. 11 uses the Example 2 fabric-unit embodiment.

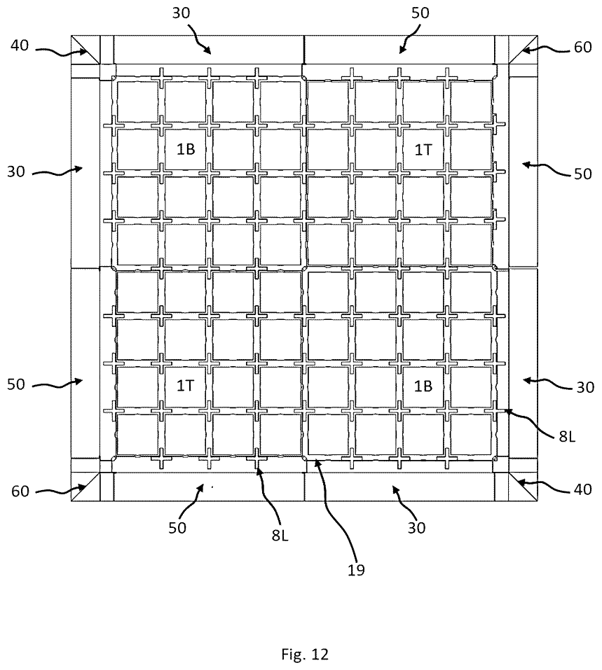

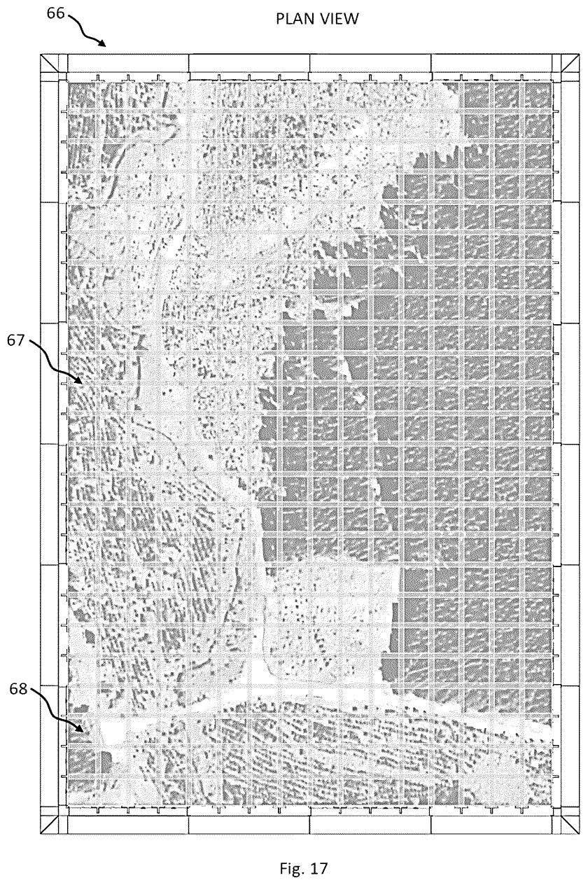

FIG. 12 illustrates the addition of cosmetic edge panels being another preferred embodiment.
FIG. 17 illustrates a much larger rectangular RPG board containing 24 fabric-units that are manufactured using a preferred high optical-transparency plastic material, cosmetic edge panels and a representative background graphic layer being other preferred embodiments.

FIG. 3 and FIG. 4 label four HECs (3) on side BA of the preferred 4×4 fabric-unit. All four sides are identical in design and HEC labelling. FIG. 3A and FIG. 4A show the HEC labelling convention, whereby looking from top view, left side, the four HECs (3T) are labelled 3T1=left HEC, 3T2=mid-left HEC, 3T3=mid-right HEC and 3T4=right HEC. As shown in FIG. 3B and FIG. 4B, the same side BA and the same four HECs viewed from the bottom side (3B) are similarly labelled 3B1, 3B2, 3B3 and 3B4.

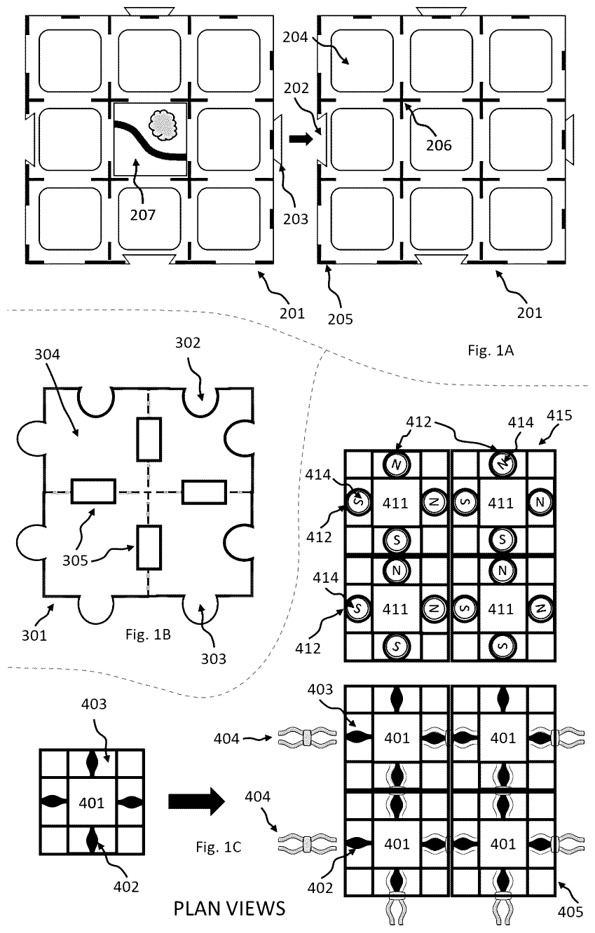

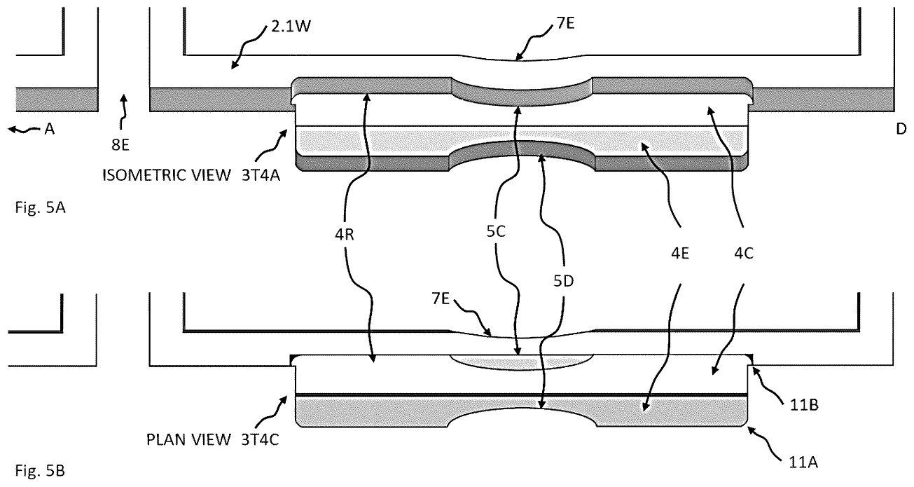

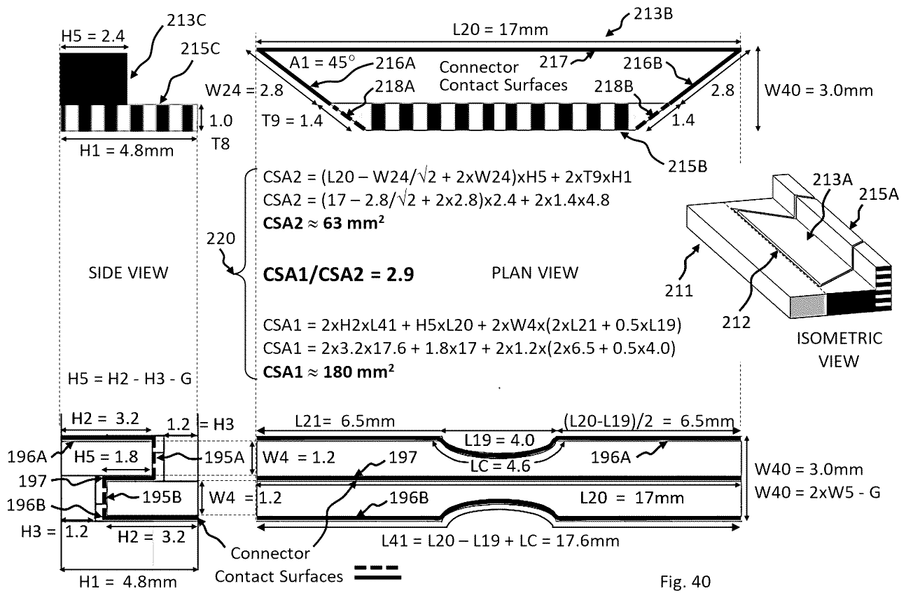

As illustrated in detail in FIG. 5, a HEC comprises a preferred “lip and channel” structure (4E and 4C respectively) which with other preferred embodiments to be described has typically 3 times greater contact surface area (FIG. 40—220) and hence higher binding strength in all 3 dimensions compared to simple jig-saw type edge connectors (FIG. 1A—202, 203) of the same dimensions. FIG. 5A shows an isometric view of a HEC (3T4A) and FIG. 5B shows a plan view of a HEC (3T4C).

As illustrated in FIG. 3 and FIG. 4, the fabric-unit comprises low profile structural walls called “crossbars” (6L and 6W) that run the length and width of the fabric-unit which combined with outer walls (2.1L and 2.1W) of outer fabric-cells (2.1) define the dimensions of the fabric-cells. With preferred dimensions (FIG. 37), dimensional relationships (FIG. 39), and light-weight plastic materials, the said crossbars, outer walls and 16 HECs per fabric-unit provide the strength needed for constructing a self-supporting game board containing a plurality of fabric-units. Note, throughout the description, drawings and claims, interpret outer walls and outer cell walls as synonymous.

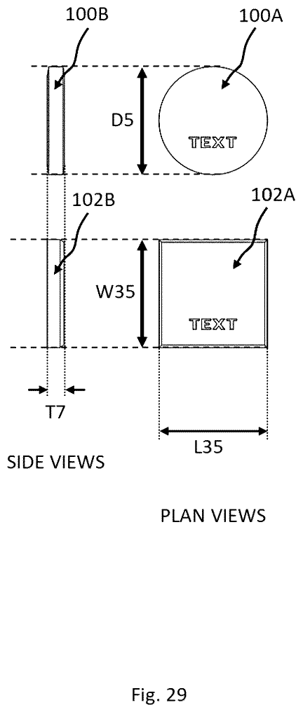

FIG. 16 illustrates a commercial off-the-shelf or 3D printed game piece (97) that is integrated with a square or circular game piece base (98-102). For a preferred embodiment of the present invention, compatible square and slightly larger-diameter circular bases are simultaneously supported by indenting the centre of each cell wall (7C and 7E) as if cut-out by the perimeter of a circle (7P) having a diameter that is slightly larger than a circular game piece base that the fabric-cell is dimensioned to support. By way of example, fabric-unit dimensions listed in FIG. 37 are designed to support 25 mm square or circular and 25.4 mm (1 inch) circular 3D game piece base dimensions (FIG. 29—L35, W35, D5-2 and T7) as listed in FIG. 38. Larger gaming industry 3D game pieces are similarly supported by linearly scaling the L, W and D parameters for the fabric-cell dimensions and resultant fabric-unit dimensions. Other 3D game piece dimensions adopted by the gaming industry include for example: 28 mm, 30 mm, 32 mm, 38 mm and 40 mm. In some cases, such as for greater fabric-unit connection strength, the H and T parameters may also be linearly scaled. FIG. 39 lists the dimensional relationships between significant L, W and H parameters for the purpose of linearly scaling fabric-units with the preferred embodiments.

FIG. 5 illustrates additional preferred embodiments of a HEC, whereby the preferred lip and channel structure comprises matching convex bumps (5C) and concave dimples (5D) on the channel walls (4C) and lips (4E) respectively for increasing the contact surface area and connection strength, and for aiding the alignment of adjacent fabric-units when being joined, and for preventing sideways slippage of connected fabric-units when joined. The fabric-unit Example 2 embodiment additionally provides a recess (4R) in the associated fabric-cell's outer wall (2.1W) for the HEC channel (4C) for aiding the alignment of adjacent fabric-units when being joined, and for preventing sideways slippage of connected fabric-units when joined. The fabric-unit Example 2 embodiment also comprises rounded corners (11A, 11B) to improve the ease of making connections between adjacent fabric-units.

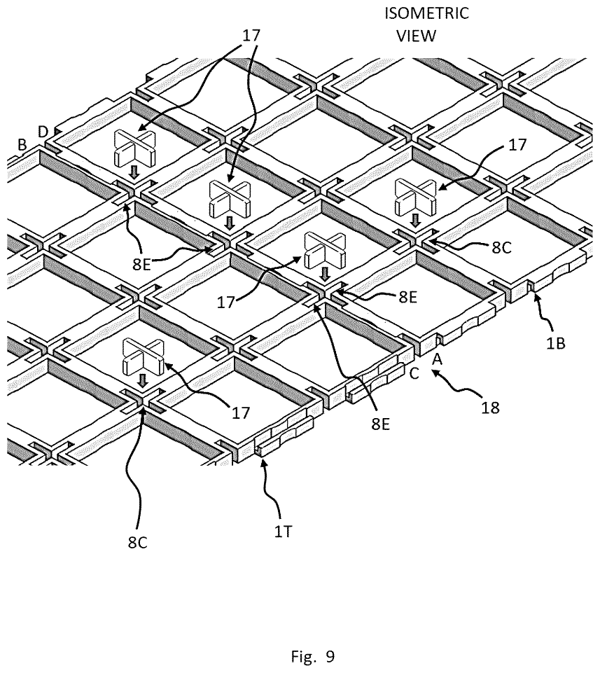

In a preferred embodiment, enhancements to the fabric-unit structure comprise slots in the form of female cross-connectors (FIG. 3, FIG. 4—8C, 8E) that pass from the top to the bottom of the fabric-unit for the attachment of male cross-connectors (FIG. 9—17) that are compatible with said female cross-connectors. The slots (8C) are referred to a full female cross-connectors. The slots (8E) are referred to as half female cross-connectors. As shown in FIG. 9, when two fabric-units are joined (18), the interconnected half female cross-connectors effectively become a full female cross-connector.

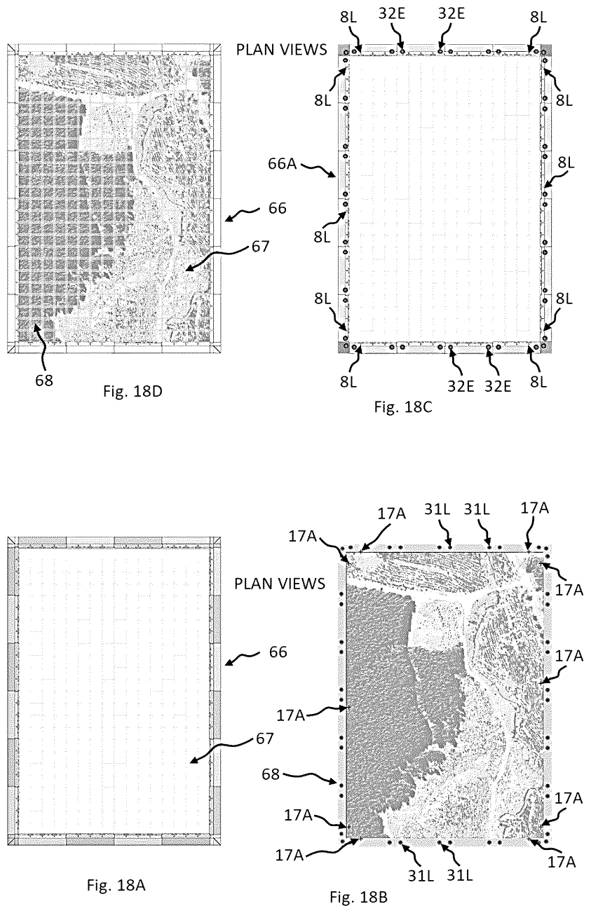

As shown in FIG. 19, the male cross-connectors are intended to be affixed to game board accessories such as buildings (88-91), walls (92-96), and trees for example which are then attached to the female cross-connectors (8C or 8E) via the top side of the fabric-units. As shown in FIG. 18, the male cross-connectors (17A) are also intended to be affixed to an optional background graphic layer (68) that is defined by or for the game being played. The background graphic layer is then attached to the female cross-connectors (8C, 8E or 8L in the case of an edge panel) via the underside of the fabric-units and edge panels used to construct the game board. The background graphic layer may simply comprise a 2D printed graphic that is laminated with transparent plastic.

Methods of affixing male cross-connectors include glue for the background graphic layer and for commercial off-the-shelf game accessories, or integrating a 3D print (.stl) model of compatible male cross-connectors into 3D print (.stl) models of game accessories (FIG. 19—89), either licensed or designed by the user.

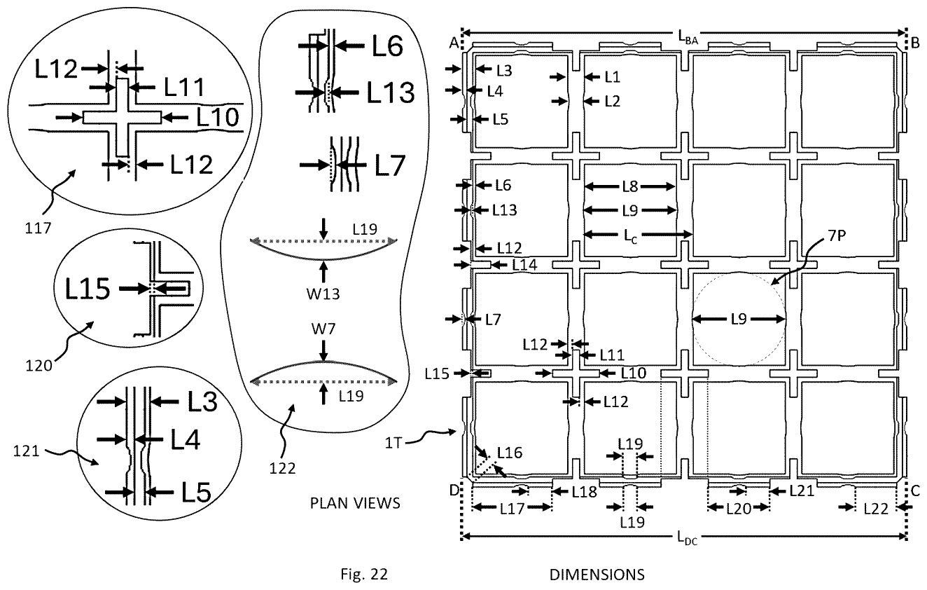

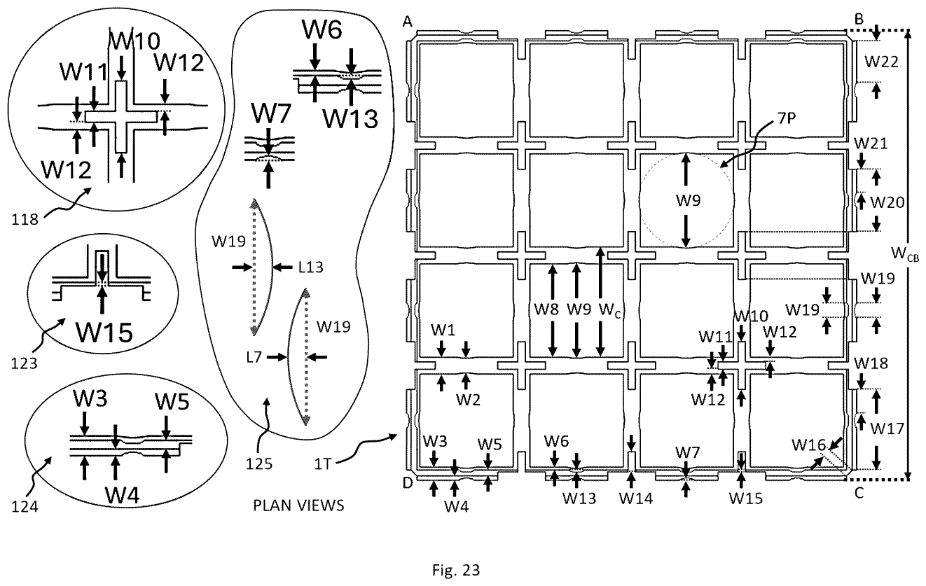

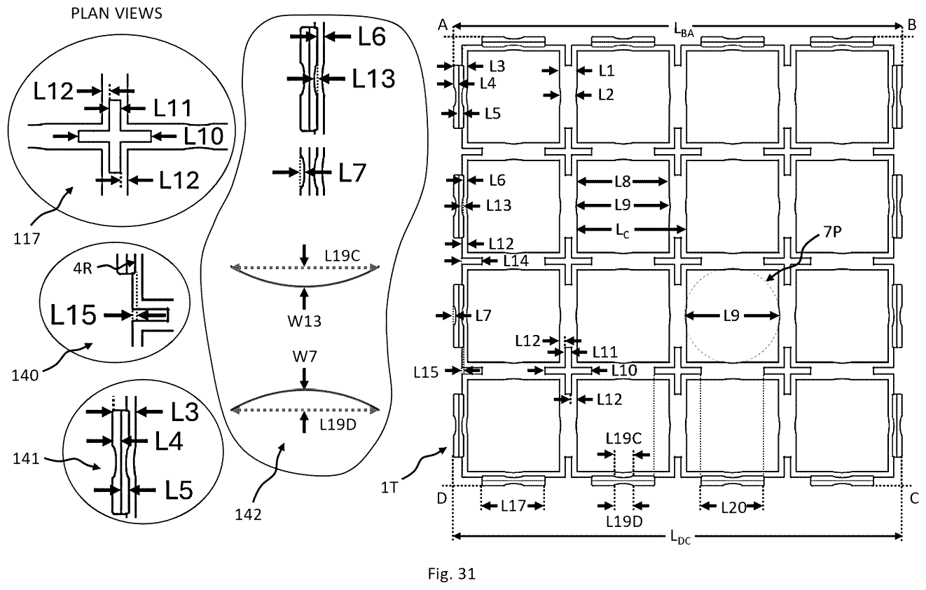

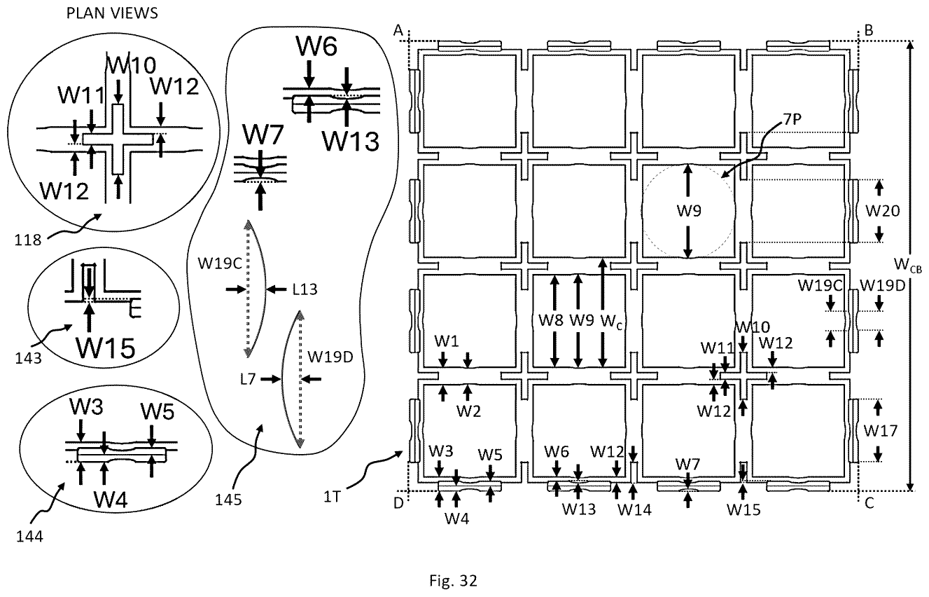

Referring to the dimensions defined in FIG. 22 and FIG. 23 for Example 1 fabric-units and FIG. 31 and FIG. 32 for Example 2 fabric-units, the two Example embodiments (1 & 2) follow the same design principles as defined by dimensional relationships DR9 and DR10 in FIG. 39, being that for a given fabric-cell spacing (L_{C}, W_{C}), the size and bonding strength of the HECs (2L₁₇+2L₂₀ and 2W₁₇+2W₂₀) are reduced by the size of the female cross-connectors (L₁₀ and W₁₀). However, dimensional relationships DR9 and DR10 provide scope to optimise the size L₁₇ and W₁₇ of the left and right HECs (FIG. 3A—3T1 and 3T4) for either greater bonding strength or greater female cross-connector symmetry.

Example 1 fabric-units have longer left and right HECs for greater bonding surface area and strength but sacrifice some female cross-connectors at the corners of the Example 1 fabric-units which reduces the density and symmetry of a resultant game board's female cross-connector array (FIG. 10—8F and 8G). This can restrict the placement of game accessories.
Example 2 fabric-unit HECs all have the same dimensions (L₁₇ and W₁₇) for maximum density and symmetry of a resultant game board's female cross-connector array (FIG. 11—8J and 8K), but sacrifice some bonding surface area and strength, albeit not enough to prevent the 1^{st} objective of the present invention being met. The result is a homogenous game board whereby a game accessory such as a building can be placed anywhere on the game board.

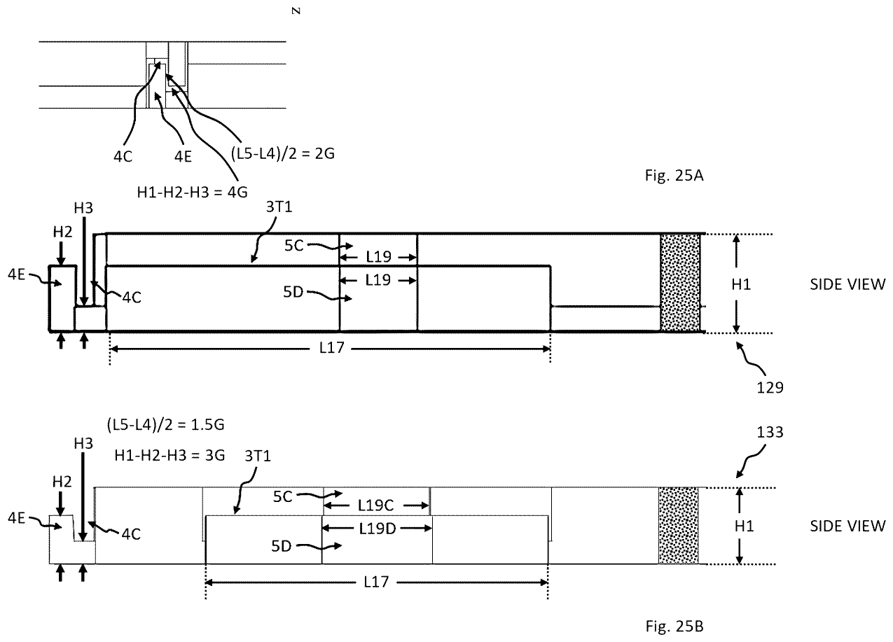

Other dimensional differences between the Example 1 and Example 2 embodiments target their preferred manufacturing methods, being 3D printed, and plastic injection moulded respectively, and their preferred materials, being any coloured plastic for 3D printing and high optical transparency plastic such as polycarbonate for injection moulding. As shown in FIG. 25B and FIG. 37 (190C), Example 2 fabric-units in turn require that the height (H₁) of the crossbars and consequently the height (H₂) of the HEC lips be reduced to increase the optical transparency of the manufactured fabric-unit without unacceptably compromising the HEC bonding strength required to meet objective 1.

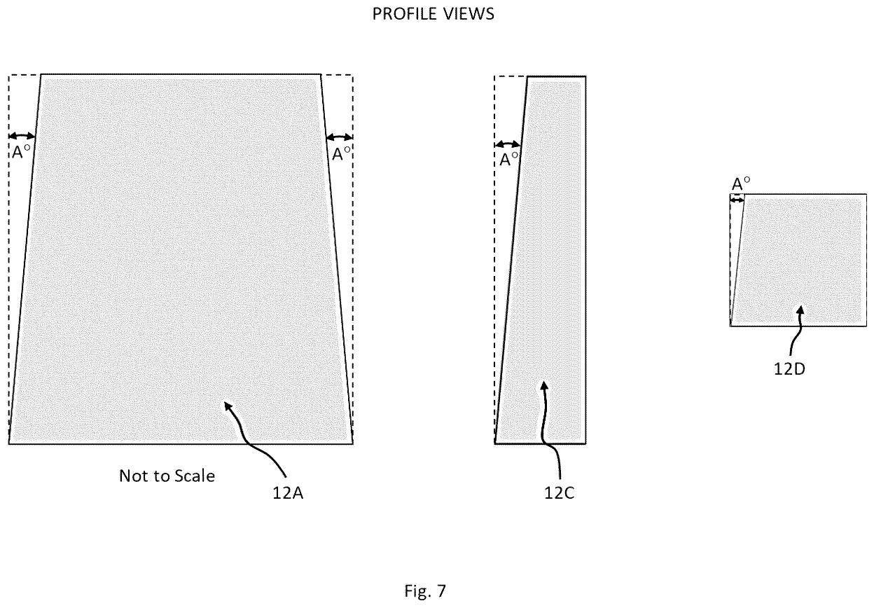

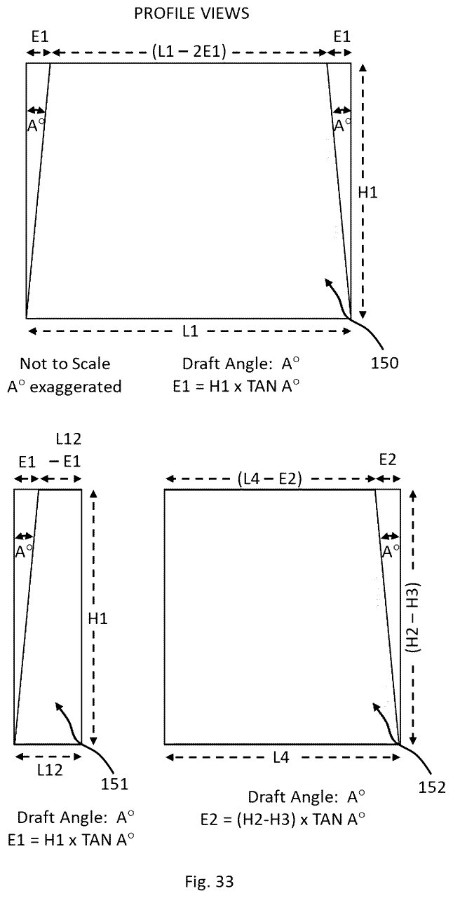

To support volume manufacturing using injection moulding of Example 2 fabric-units, a preferred embodiment of this invention comprises fabric-cell crossbars, outer cell walls and HEC lips having a draft angle A° (FIG. 7 and FIG. 33) for easier removal of the manufactured fabric-unit from its mould. The draft angle results in top and bottom dimensions of the crossbars/walls and HEC lips differing by E₁ and E₂ respectively. The difference “E” is not listed in FIG. 37 but is calculated based on the specified value of “A”.

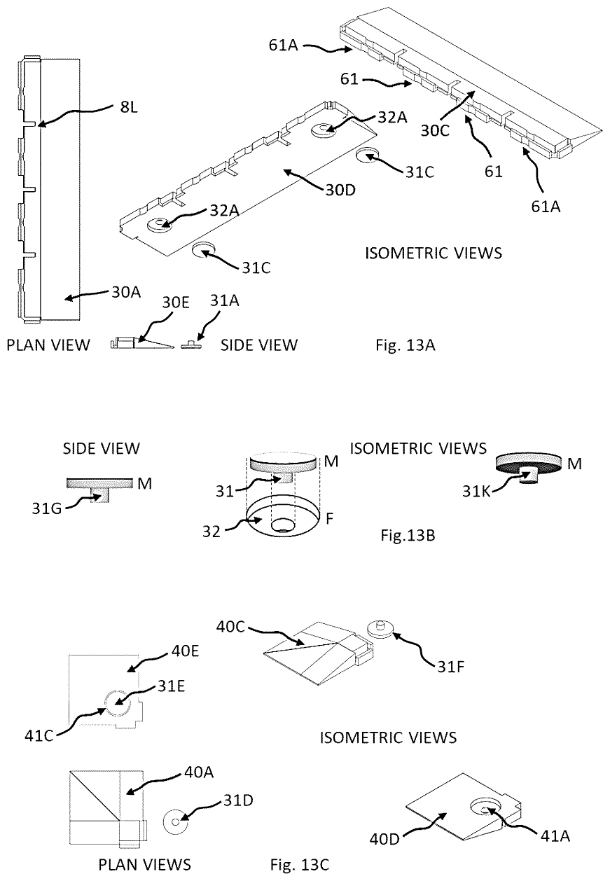

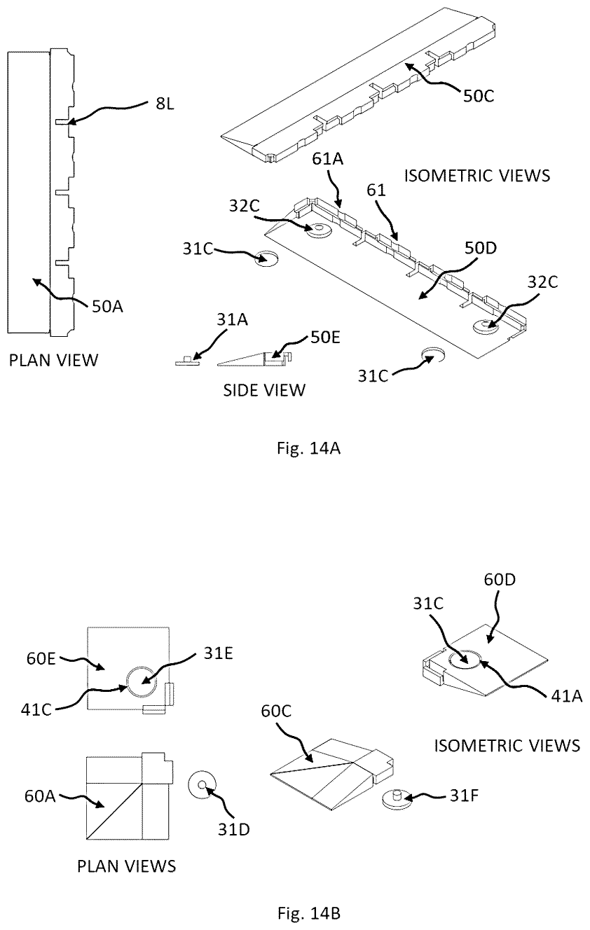

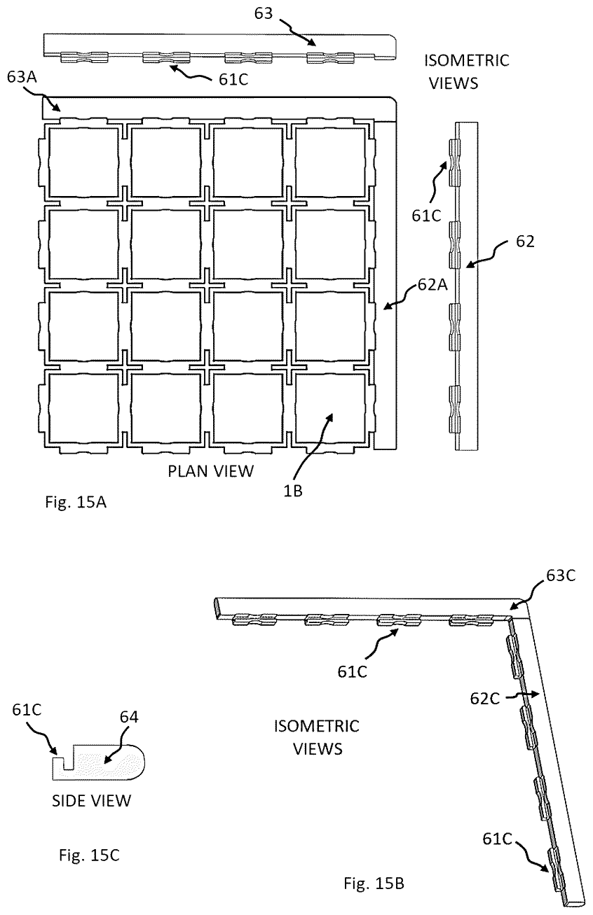

Representative cosmetic edge panels (FIG. 12—30, 40, 50, 60 and FIG. 15A—62, 63) added around the perimeter of a game board comprise edge connectors that are compatible with and connect to the fabric-unit hermaphroditic edge connectors. The corner panels (40, 60) and straight edge panels (30, 50) illustrated in FIG. 12 are tapered in height as detailed in FIG. 13 and FIG. 14 and due to this asymmetry in their height dimension, different edge panels are required for fabric-units with non-inverted HECs and inverted HECs, resulting in the need for four different edge panel designs. By making the edge panels symmetric in their design in the height dimension (FIG. 15C—64), only one straight panel design (62A) and one corner panel design (63A) is required as shown in FIG. 15A. Having fewer edge panel designs results in lower manufacturing cost.

As illustrated in FIG. 12, the tapered cosmetic edge panels comprise half female cross-connectors (FIG. 13A—8L) which become full female cross-connectors when attached to a fabric-unit (FIG. 12—8L). As illustrated in FIG. 18B, male cross-connectors (17A) affixed to a background graphic (68) are aligned so that they can be attached to the underside of said full female cross-connector locations as shown in FIG. 18C—8L.
In another embodiment, the tapered cosmetic edge panels comprise female button-hole connectors (FIG. 13B—32) to which are fitted compatible male button connectors (FIG. 13B—31) for attaching to a background graphic layer (FIG. 18B—68) instead of or in addition to male cross-connectors. The button connectors are affixed to the background graphic layer (FIG. 18B—31L) and are aligned with the matching buttonhole connectors in the edge panels (FIG. 18C—32E) for attaching the background graphic layer to the edge-panels.

The attachment of a background graphic layer and game accessories to a game board containing fabric-units meets a 2^{nd} objective of the present invention being to enable a game board containing game tiles, 3D game pieces and game accessories to be moved around on a table or to another location off the table without the game tiles, 3D game pieces and game accessories moving out of their current game squares or other locations within the said fabric-units. The background graphic layer may comprise a null graphic for the case of game tiles which comprise their own graphic. The attachment of a background graphic layer provides a base to prevent game tiles and 3D game pieces falling through the fabric-cells. The fabric-cell walls prevent the game tiles or 3D game pieces moving into adjacent game squares. The attachment of game accessories to the fabric-units prevents the game accessories from moving across the game board when it is being moved or relocated.

For the Example 1 embodiment, fabric-units comprising cell walls with low profile dimensions combined with low-profile hermaphroditic edge connectors partially meet a 3^{rd} objective of the present invention being to reduce visual obstructions to the underlying background graphic layer where this defines the game being played. To this end, the 3^{rd} objective requires that the total fabric-cell area per fabric-unit is maximised while retaining sufficient crossbar, outer wall and hermaphroditic edge connector strength needed for constructing a self-supporting game board, being the 1^{st} objective.

For the Example 2 embodiment, with its even lower profile fabric-cell and HEC walls and its high optical transparency material and injection moulded manufacturing process, the 3^{rd} objective of high visibility of the background graphic layer is fully met.

Representative dimensions of Example 1 and Example 2 fabric-units are tabulated in FIG. 37 with dimensions that are common to both examples listed in that part of the table identified as (190A) and dimensions that are different and specific to Example 2 listed in that part of the table identified as (190C).

For Example 1 and Example 2 fabric-units, representative dimensions of edge panels, game piece bases and game accessories such as male cross-connectors are tabulated in FIG. 38 with dimensions that are common to both examples listed in that part of the table identified as (191A) and dimensions that are different and specific to the Example 2 embodiment listed in that part of the table identified as (191C).

It is evident from this description of the embodiments and referenced drawings that the present invention is intended to complement, not compete with the game board industry that supplies off-the-shelf, and 3D printed game tiles, 3D game pieces and game accessories.

### DESCRIPTIONS OF PARTS AND FEATURES

There are 40 sheets of drawings and 40 Figure numbers “N” with some Figures split into multiple parts labelled FIG. NA, FIG. NB, FIG. NC etc. Reference labels “M” point to parts of a drawing using squiggly lines. Table 1 at the end of this section contains a list of all sheets, figures and first instances of reference labels with a short description of each reference label.

The dimensions of objects and various parameters are specified using straight arrows with single or double arrowheads and a dimensional label Ln, Wn, Hn, Tn, Dn, kG and A, where L=Length, W=Width, H=Height, T=Thickness, D=Diameter, kG=Gap, A=Angle and “n” is a unique object or parameter dimension which in the drawings is not shown as a subscript for greater clarity (e.g., L17), but in the representative dimensions shown in FIG. 37 and FIG. 38 and in this detailed description, it is shown as a subscript (e.g., L₁₇). Both representations of “n” are to be considered identical. The value “k” is a multiple of the likely minimum gap value “G”.

FIG. 2 illustrates plan, side and isometric views of the top side of a preferred square fabric-unit (1) comprising a 4×4 array of 16 square fabric-cells (2) and hermaphroditic edge connectors (HECs) with 4 HECs (3) per side. The labelling of each side is BA, CB, DC and AD read from the top left corner to the top right corner of each side. In plan view, the Length (L) dimensions are defined as the BA and DC directions. Width (W) dimensions are defined as the CB and AD directions. Height (H) dimensions are defined by the side views. Slots that form the female cross-connectors (8) are shown in the isometric view.

FIG. 3 illustrates plan views of the top side (T) and bottom side (B) of a fabric-unit Example 1. Also shown is an isometric zoomed in view (3T3Z) of a mid-right HEC labelled 3T3. FIG. 4 similarly illustrates plan views of the top side (T) and bottom side (B) of a fabric-unit Example 2. The following drawing details apply to both FIG. 3 and FIG. 4 unless stated otherwise.

Illustrated in FIG. 3A and FIG. 4A are the 4 HECs per side labelled top left to top right as 3T1 to 3T4. Each HEC comprises a lip (4E) and channel (4C) section with preferred bumps (5C) and dimples (5D). The lip (4E) is facing upwards which defines a non-inverted fabric-unit. In FIG. 3B and FIG. 4B the bottom of each lip and channel section is shown as 3B1 to 3B4 with each lip (4E) shown facing downwards which defines an inverted fabric-unit.
Also illustrated in FIG. 3 and FIG. 4 are the following:
a) 12 outer cells (2.1) with outer cell walls (2.1L) and (2.1W) that the HECs attach to,
b) 4 inner cells (2.2),
b) 3 crossbars (6L) and 3 crossbars (6W),
c) 9 full female cross-connectors (8C).
d) 12 half female cross-connectors (8E) for fabric-unit Example 1,
e) 12 half (8E) and 4 quarter (8J) female cross-connectors for fabric-unit Example 2,
f) Circular indents 7C in crossbars and 7E in outer cell walls defined by circle perimeter 7P.

Illustrated in FIG. 5 are zoomed-in isometric (3T4A) and plan views (3T4C) of fabric-unit Example 2. All previously discussed embodiments (4E, 4C, 5C, 5D, 7E, 8E) are shown in detail. Additional embodiments are a recess (4R) in the outer wall 2.1W for the channel 4C and rounded corners 11A and 11B.

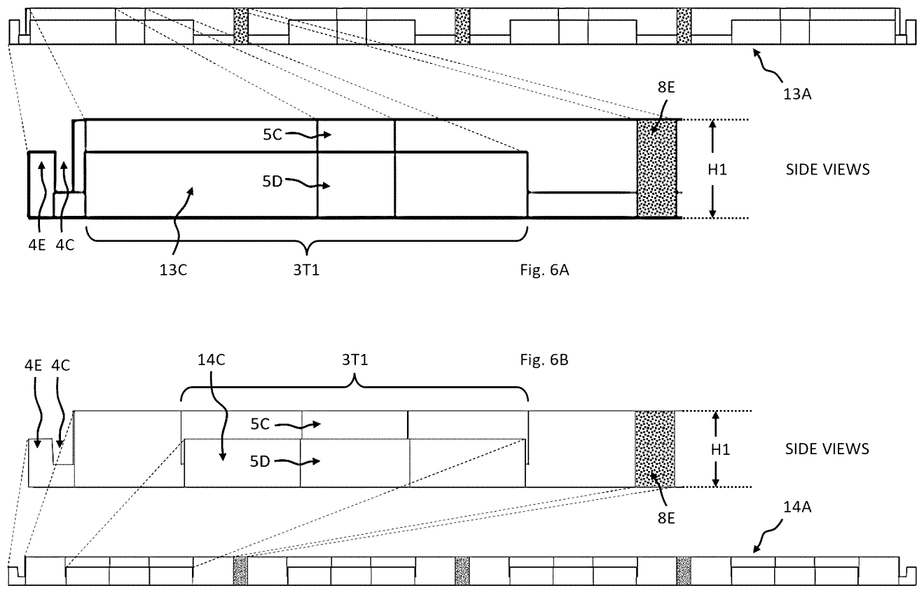

Illustrated in FIG. 6A is a fabric-unit Example 1 side view (13A) with a zoomed-in view of HEC 3T1 (13C). Illustrated in FIG. 6B is a is a fabric-unit Example 2 side view (14A) with a zoomed-in view of HEC 3T1 (14C).

Shown are side views of embodiments 4E, 4C, 5C, 5D and 8E. It is evident that the height dimensions H₁ for the fabric-unit Example 2 crossbars and outer cell walls are slightly smaller than for fabric-unit Example 1. This is required for the preferred objective 3 embodiment where the plastic material used to manufacture fabric-unit Example 2 has both high strength and high optical transparency such as polycarbonate. As shown in FIG. 37 (190C), H₁ for HEC Example 2 is 3.8 mm compared to 4.8 mm for HEC Example 1 (190A). These are representative height dimensions for these embodiments.

FIG. 7 illustrates the addition of a draft angle A° to the crossbars (12A), outer cell walls (12C) and HEC lips (12D) for the preferred fabric-unit Example 2 embodiment where the fabric-unit is to be manufactured using the injection moulding method. The draft angle enables easier removal of the mould without damaging the fabric-cell and HEC walls.

FIG. 8A illustrates a side view of an inverted fabric-unit (15B) about to be joined to an adjacent non-inverted fabric-unit (15A). It is seen that HEC lip 4E on side CB of fabric-unit 15A will be fitted to HEC channel 4C on side CB (or any other side) of fabric-unit 15B.

FIG. 8B illustrates a side view of an inverted fabric-unit (15B) joined (16) to an adjacent non-inverted fabric-unit (15A). Necessary horizontal and vertical gaps (4F) are required between the connected lip (4E) and channel (4C) to allow for manufacturing tolerances while maintaining a high connector binding strength between adjacent fabric-units. Referring to FIG. 38 where a reference gap dimension G=0.1 mm is defined and FIG. 39, where the representative horizontal gap dimensions for the Example 1 and Example 2 embodiments are calculated to be DR17=2 G and DR18=1.5 G respectively. The representative vertical gap dimensions for the Example 1 and Example 2 embodiments are calculated to be DR19=4 G and DR20=3 G respectively.

FIG. 9 illustrated an isometric view of non-inverted (1T) and inverted (1B) fabric-units of the Example 2 embodiment joined (18) on sides CB and AD respectively. Full female cross-connectors (8C) and half female cross-connectors (8E) are shown whereby the joining of two half-female cross-connectors creates a full female cross-connector. Compatible male cross-connectors (17) having slightly smaller dimensions are shown aligned to and ready to be fitted to female cross-connectors.

FIG. 10 illustrates a plan view of 4 fabric-units of the Example 1 embodiment connected to construct an 8×8 {64} cell game board (19) for a traditional game such as Chess. Labelled are non-inverted fabric-units (1T) and associated HECs (3T1, 3T2, 3T3, 3T4) and inverted fabric-units (1B) and associated HECs (3B1, 3B2, 3B3, 3B4). The centre of the game board where the 4 fabric-units have a common corner (8F) is shown to not have a full female cross-connector. This is an example of the female cross-connector asymmetry caused by the Example 1 embodiment which trades off this symmetry for greater bonding strength of the fabric-units. Corner 8G is another example of this female cross-connector asymmetry. For traditional game boards such as Chess where game accessories are not required, then this female cross-connector asymmetry is less important.

FIG. 11 illustrates a plan view of 4 fabric-units of the Example 2 embodiment connected to construct an 8×8 {64} cell game board (20) for a traditional game such as Chess. Labelled are non-inverted fabric-units (1T) and associated HECs (3T1, 3T2, 3T3, 3T4) and inverted fabric-units (1B) and associated HECs (3B1, 3B2, 3B3, 3B4). At the centre of the game board where 4 fabric-units have a common corner, their quarter female cross-connectors (8J) join to effectively create a full female cross-connector. This is an example of the female cross-connector symmetry enabled by the Example 2 embodiment which trades off female cross-connector symmetry for a slight reduction in bonding strength of the fabric-units. Corner 8K is another example of this female cross-connector symmetry. For RPGs such as Dungeons and Dragons, the Example 2 fabric-unit embodiment is preferred so that game accessories can be placed anywhere on the game board without limitations.

FIG. 12 is an example of an 8×8 {64} cell game board (19) constructed using the Example 1 fabric-unit embodiment and with cosmetic edge panels with tapered edges installed around the perimeter of the game board. Straight edge panels (50) and corner edge panels (60) connect to non-inverted fabric-units. Straight edge-panels (30) and corner edge panels (40) connect to inverted fabric-units.

Simple variants of these tapered edge panels can also be provided for the fabric-unit Example 2 embodiment. There are 4 variants of tapered edge panels required to fully enclose any game board constructed using Example 1 and Example 2 fabric-units according to the present invention. The tapered edge panels may be coloured or may comprise a highly optically transparent plastic material.

FIG. 13A illustrates details of straight edge panels (30) comprising edge connectors that match the inverted Example 1 fabric-units (FIG. 12—1B) and include small edge connectors on their side for attaching corner edge panels (40). Shown is a plan view top side (30A), isometric views top side (30C) and bottom side (30D), and side view (30E). Half female cross-connectors (8L) are included that will become full female cross-connectors when the straight edge panel is attached to an Example 1 fabric-unit.

An optional embodiment is the addition of low-profile female buttonhole connectors (32A) to which can be attached compatible male button connectors (31A, 31C) that can be affixed to a background graphic layer for the purpose of attaching the background graphic layer to the edge panels as an alternative to or in addition to the use of male cross-connectors when used for the same purpose.
FIG. 13B illustrates zoomed-in views of the female (F) buttonhole connectors (32) and male (M) button connectors (31, 31G, 31K). The compatible button connectors should have a tight fit to the buttonhole connectors.
FIG. 13C illustrates details of corner edge panels (40) comprising edge connectors that match the straight edge panels (30) to which they connect. Shown are plan views top side (40A) and bottom side (40E), isometric views top side (40C) and bottom side (40D), and optional female buttonhole connectors (41A, 41C) and compatible male button connectors (31D, 31E, 31F).

FIG. 14A illustrates details of straight edge panels (50) comprising edge connectors that match the non-inverted Example 1 fabric-units (FIG. 12—1T) and include small edge connectors on their side for attaching corner edge panels (60). Shown is a plan view top side (50A), isometric views top side (50C) and bottom side (50D), and side view (50E). Half female cross-connectors (8L) are included that will become full female cross-connectors when the straight edge panel is attached to an Example 1 fabric-unit.

Also shown are the optional low-profile female buttonhole connectors (32C) to which can be attached compatible male button connectors (31A, 31C) that can be affixed to a background graphic layer.
FIG. 14B illustrates details of corner edge panels (60) comprising edge connectors that match the straight edge panels (50) to which they connect. Shown are plan views top side (60A) and bottom side (60E), isometric views top side (60C) and bottom side (60D), and optional buttonhole connectors (41A, 41C) and compatible button connectors (31D, 31E, 31F).

FIG. 15A illustrates plan and isometric views of low profile symmetrical (in height) edge panels with edge connectors matched to the Example 2 embodiment of a fabric-unit. Since the edge panels have a symmetrical height profile (64) as shown in FIG. 15C, only two variants of straight edge panel (62) and corner edge panel (63) are required to fully enclose any game board constructed using Example 2 fabric-units according to the present invention.

The isometric views of the edge panels show edge connectors (61C) which are all identical when designed for connection to Example 2 fabric-units. The plan view shows an inverted Example 2 fabric-unit (1B) to which has been connected a straight edge panel (62A) and a corner edge panel (63A). By virtue of their symmetry in height, the same edge panels can be inverted and connected to a non-inverted Example 2 fabric-unit.
FIG. 15B illustrates another isometric view of straight (62C) and corner (61C) edge panels.
FIG. 15C illustrates a side view of the edge panels showing the lip and channel of the edge connector (61C) that matches the HECs for the Example 2 embodiment of a fabric-unit.

FIG. 16 illustrates a plan view cutout of a fabric-unit with a zoomed-in view of the circular indents (7C, 7E) in the fabric-cell walls, being a preferred embodiment for supporting both square bases (101, 102) and slightly larger circular bases (98, 99, 100) for 3D game pieces (97).

This preferred embodiment specifically targets 25 mm square and 25.4 mm (1 inch) circular game piece bases. The circular indents are defined by the perimeter of a circle (7P) having a diameter that is slightly larger than a 25.4 mm circular base for providing manufacturing and game piece installation tolerances.
As defined in FIG. 22, FIG. 23, FIG. 31 and FIG. 32, the circle (7P) diameter has equal dimensions L₉ and W₉ which in FIG. 37 are shown to have a representative value of 26.0 mm, thus providing a 0.3 mm gap between the indents (7C, 7E) and the perimeter of the game piece base. For 25 mm square game pieces, the fabric-cell dimensions (L₈, W₈) have a representative value of 25.4 mm thus providing a 0.2 mm gap between each fabric-cell wall and each side of the 25 mm square game piece base.

FIG. 17 illustrates the plan view of a 16×24 {384} cell game board (66) constructed using 24 fabric-units of the Example 2 embodiment. Common features of Example 1 and Example 2 fabric-units include low profile crossbars, outer cell walls and HECs for increasing the visibility of a preferred background graphic layer. The Example 2 fabric unit is preferably manufactured using injection moulding of a high optical transparency plastic material such as polycarbonate which as shown (67), further increases the visibility of a background graphic layer (68). The background graphic layer is attached to the underside of the fabric-units and edge panels. The crossbars, outer cell walls and HECs have been drawn in this case to better illustrate their optical transparency and resultant visibility of the under-lying background graphic. These features are most suited to RPGs such as Dungeons and Dragons. For illustrative purposes only, not shown are the symmetrical array of female cross-connectors for attaching RPG game board accessories such as buildings, walls and trees.

FIG. 18 illustrates a plan view of the assembly process for attaching a background graphic layer to the underside of the game board shown in FIG. 17.

FIG. 18A illustrates the bare game board (66) constructed using Example 2 fabrics units and associated tapered edge panels.
FIG. 18B illustrates the background graphic layer (68), which may simply comprise a 2D printed graphic that is relevant to the RPG game being played, said graphic being laminated using a transparent plastic material. Male cross-connectors (17A) and male button connectors (31L) are shown affixed to the background graphic layer, pre-aligned with the outer perimeter of the fabric-units and the edge panels respectively.
Where there are no game board accessories using female cross-connectors, additional male cross-connectors may be affixed to other parts of the background graphic layer for increased attachment strength to the fabric-units and for increasing the self-supporting strength of the game board, being the 1^{st} objective.
A pre-alignment process is to invert the game board (66A) as shown in FIG. 18C, then partly insert the unattached male cross-connectors and button connectors into the target female cross-connectors (8L) and female buttonhole connectors (32E) respectively. Next, apply some glue to the visible part of the male cross-connectors and male button connectors so that the bare background graphic layer (68) can be inverted (graphic facing down), aligned and then placed onto the glue layer until the glue hardens. The background graphic layer and affixed male cross-connectors and male button connectors can then be removed in one piece, or it can be immediately pressed fully into the female cross-connectors and female buttonhole connectors of the game board resulting in the complete assembly shown in FIG. 18D.

FIG. 19 illustrates an isometric view of a 4 fabric-unit section of an RPG game board (80) containing a 3D game piece (97A fitted to fabric-cell (2B) plus examples of game board accessories such as a building (88) and a wall (92) attached to or to be attached to the game board using compatible male cross-connectors (17K) that have been affixed by glue or other means to the underside of the game accessories. Said other means includes the integration of compatible male cross-connectors into the 3D print design of game accessories. Making the male cross-connector dimensions and their required locations accessible to game accessory designers and users as “.stl” 3D print files enables them to design game accessories that fit perfectly into a game board that has been constructed using a preferred embodiment of the fabric-unit and associated female cross-connectors (8C, 8E, 8L).

Other aspects and views are outlined below:
a) Different views of the building accessory (89,90, 91) showing the location of compatible male cross-connectors (17L, 17M),
b) Different views and types of wall accessories (93, 94, 95,96) showing the location of compatible male cross-connectors (17J), and
c) Different views of male cross-connectors (17D, 17E, 17F, 17G).

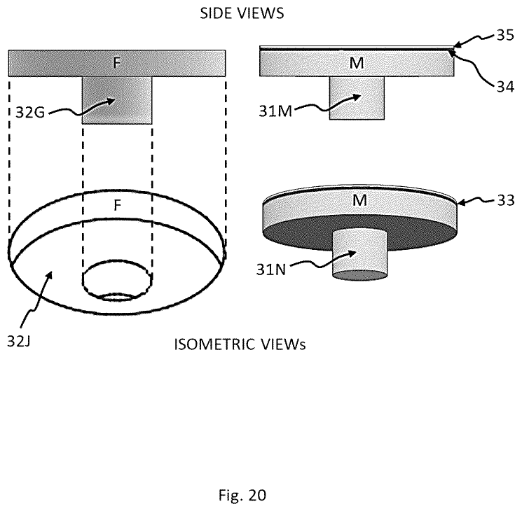

FIG. 20 illustrates side and isometric views of the female (F) buttonhole connectors (32G, 32J) and compatible male (M) button connectors (31M and 31N) detailing an option for the latter to include an adhesive sticker (33) for attaching to a background graphic layer, said sticker comprising a glue layer (34) and a removeable waxed paper or plastic cover (35).

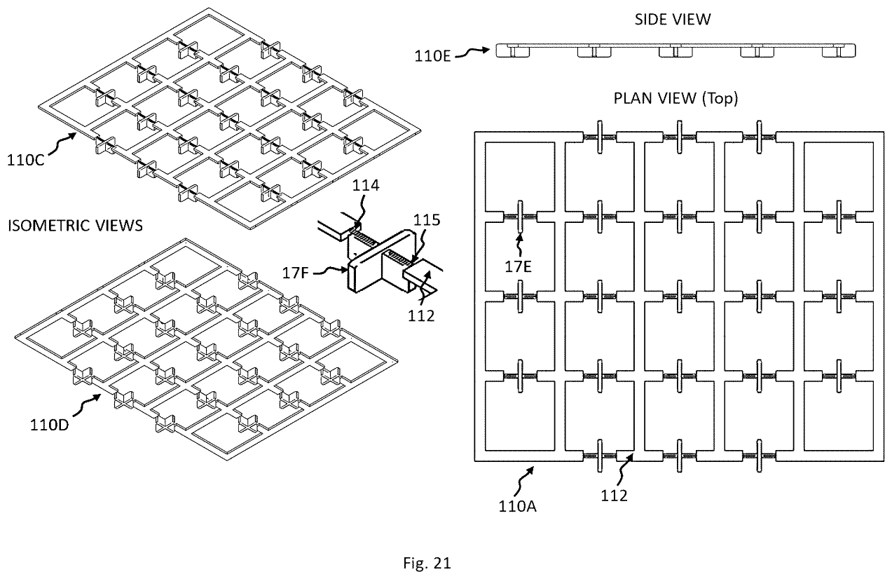

FIG. 21 illustrates how a 3^{rd} party could use injection moulding methods to manufacture an array of compatible male cross-connectors for affixing to a background graphic layer and to game board accessories that are purchased off-the-shelf and not available to be 3D printed. Zoomed-in views of the male cross-connectors are shown (17E, 17F) attached to parts of a male cross-connector array that are aligned to the target female cross-connector locations. Drawing labels are described below:
110A Male Cross-Connector Array—Top Side—Plan View|
112 Plastic Breakaway Holder typical of an injection moulding process
114 Thin Plastic Connection 1 typical of an injection moulding process
115 Thin Plastic Connection 2 typical of an injection moulding process
1110C Male Cross-Connector Array—Top Side—Isometric View
110D Male Cross-Connector Array—Bottom Side—Isometric View
110E Male Cross-Connector Array—Side View

### Fabric-Unit, Edge Panel and Game Piece Base Dimensions

This section revisits previous drawings and defines dimensions, dimensional relationships and assigns representative values to each based on preferred embodiments of the present invention.

FIG. 22 illustrates the plan view of a fabric-unit with the Example 1 embodiment and defines predominantly length (L) dimensions for objects and all necessary parameters of the 4×4 array of 16 fabric-cells. FIG. 37 (190A) tabulates these parameters and assigns representative values to them.

In FIG. 22, drawing 1T is a top side plan view of the fabric-unit. Zoomed-in view 117 defines the dimensions and the location of the full female cross-connectors. Zoomed-in view 120 defines the location of the half female cross-connectors. Zoomed-in view 121 defines the HEC lip and channel dimensions and their location. Zoomed-in view 122 defines the convex bump and concave dimple dimensions and their location, as well as their width (W).
The following description explains the dimensional theory behind the modular game board design using fabric-units specified by the present invention.
Dimensional relationship DR2 in FIG. 39 shows that the nominal length L_{F} of a fabric-unit equals the spacing between fabric-cells L_{C} multiplied by the number {4} of fabric-cells per side. As shown in FIG. 37, L_{C}=30.0 mm and hence L_{F}=120 mm. The full length of a fabric-unit is defined in FIG. 22 as L_{BA} and the representative value for this parameter is 122.6 mm (FIG. 37—190A). This is larger than the nominal fabric-unit length L_{F} since the inverted and non-inverted hermaphroditic edge connectors overlap which has a subtractive effect as defined by dimensional relationship DR15 in FIG. 39. As a result, when two fabric-units are connected, the spacing between fabric-cells across the HEC connection continue to be L_{C}=30.0 mm, resulting in a homogenous game board design with no spacing discontinuities between female cross-connectors. As a result, game accessories can be attached across connections between adjacent fabric-units without male to female cross-connector mis-alignment issues. This is true for preferred fabric-unit embodiments Examples 1 & 2.

FIG. 23 illustrates the plan view of a fabric-unit (1T) with the Example 1 embodiment and defines predominantly width (W) dimensions for objects and all necessary parameters of the 4×4 array of 16 fabric-cells. Since for the preferred embodiment, both the fabric-unit and the fabric-cells are square in shape, the width dimensions are identical to the equivalent length dimensions described in para [0061]. The associated width dimensions for objects, parameters and their values are drawn in FIG. 23 and listed in FIG. 37.

In FIG. 23, drawing 1T is a top side plan view of a fabric-unit. Zoomed-in view 118 defines the dimensions and the location of the full female cross-connectors. Zoomed-in view 123 defines the location of the half female cross-connectors. Zoomed-in view 124 defines the HEC lip and channel dimensions and their location. Zoomed-in view 125 defines the convex bump and concave dimple dimensions and their location, as well as their length (L).

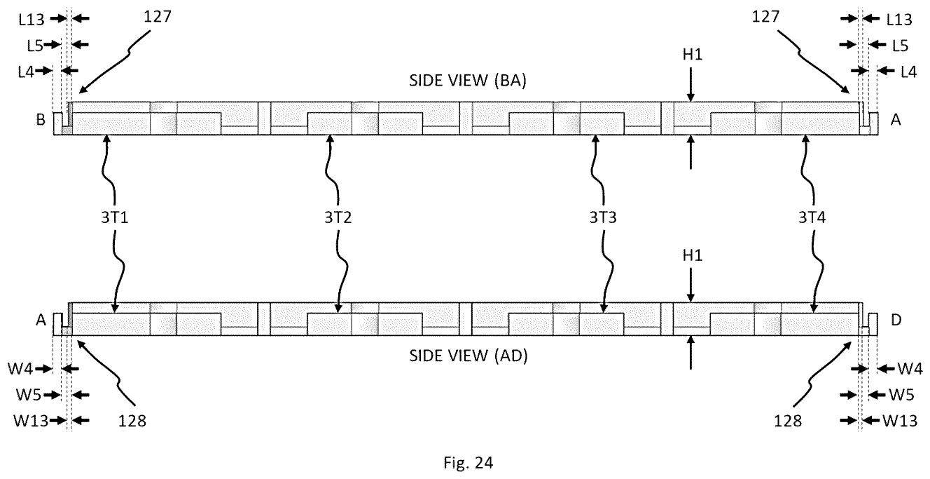

FIG. 24 illustrates the side views of a fabric-unit with the Example 1 embodiment showing the length (L) and width (W) dimensions for the left (3T1) and right (3T4) HECs on adjacent sides BA (127) and AD (128) of the fabric-unit. The fabric-unit height H₁ is also shown, being the same for all 4 sides.

FIG. 25 illustrates the side views of a fabric-unit with both Example 1 (FIG. 25A—129) and Example 2 (FIG. 25B—133) embodiments showing the length (L) and height (H) dimensions for left HEC 3T1 including HEC lip (4E), HEC channel (4C), HEC convex bump (5C) and HEC concave dimple (5D).

FIG. 25A also illustrates two connected Example 1 fabric units for the purpose of defining the average horizontal and vertical tolerance gaps between the HEC channel and lip walls, being: Horizontal gap: (L5−L4)/2=2 G and Vertical gap: H1−H2−H3=4 G where G=0.1 mm.
FIG. 25B similarly states the average horizontal and vertical tolerance gaps between the HEC channel and lip walls for two connected Example 2 fabric units, being: Horizontal gap: (L5−L4)/2=1.5 G and Vertical gap: H1−H2−H3=3 G where G=0.1 mm.
Representative dimensional values for the fabric-units are tabulated in FIG. 37 with common dimensions for Example 1 and Example 2 embodiments in section 190A and Example 2 specific values in section 190C.

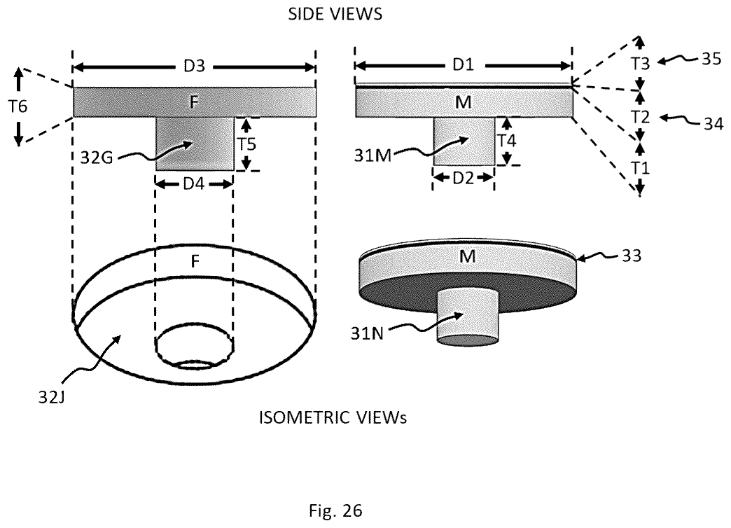

FIG. 26 illustrates side and isometric views and dimensions of the female (F) buttonhole connectors (32G) and male (M) button connectors (31M) including the thickness dimensions of the glue layer (34) with the wax paper or plastic cover (35).

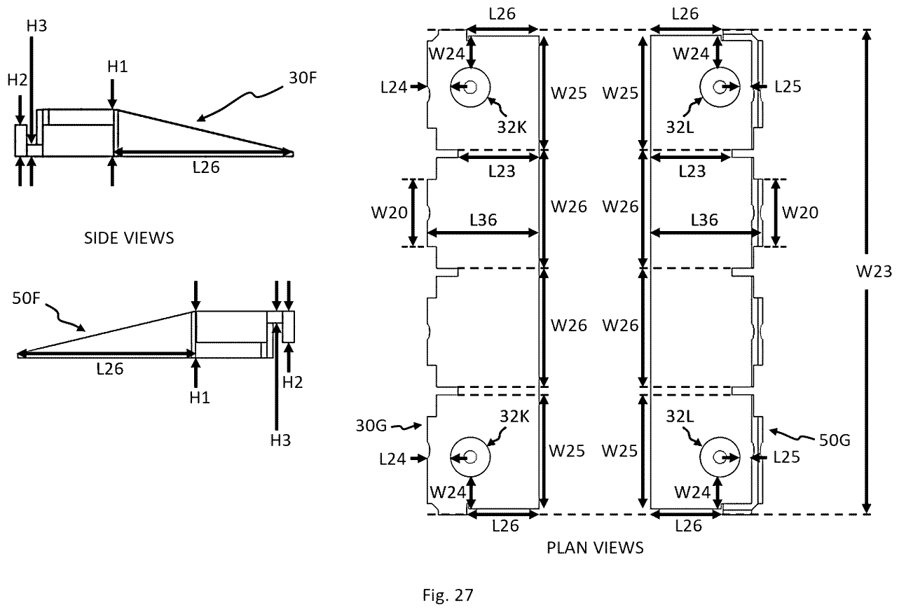

FIG. 27 illustrates plan views bottom side (50G and 30G) and side views (50F and 30F) of straight edge panels and their length (L), width (W) and height (H) dimensions.

Representative dimension values for the edge panels, game piece bases and game accessories are tabulated in FIG. 38 with common dimensions for Example 1 and Example 2 embodiments in section 191A and Example 2 specific values in section 191C.

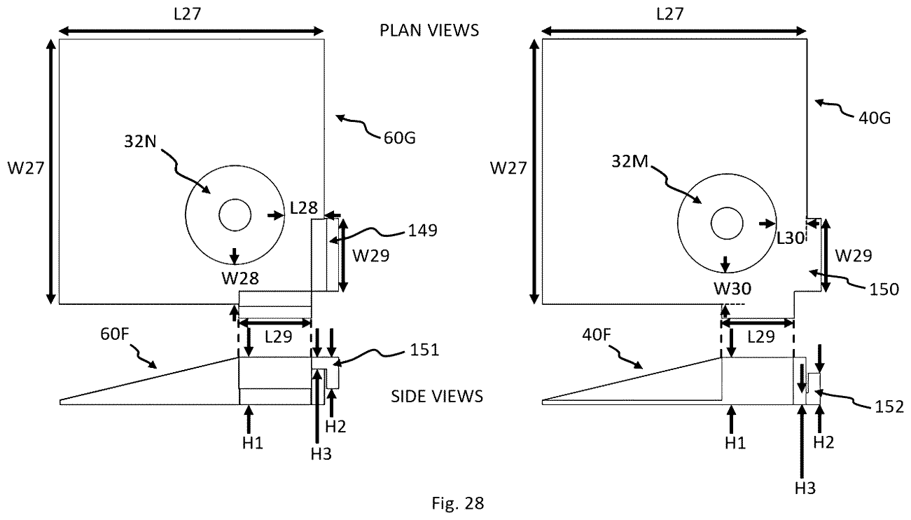

FIG. 28 illustrates plan view bottom side (60G and 40G) and side views (60F and 40F) of corner edge panels and their length (L), width (W) and height (H) dimensions.

FIG. 29 illustrates plan and side views of circular game piece bases (100A and 100B) and square game piece bases (102A and 102B) and their length (L), width (W) and height (H) dimensions.

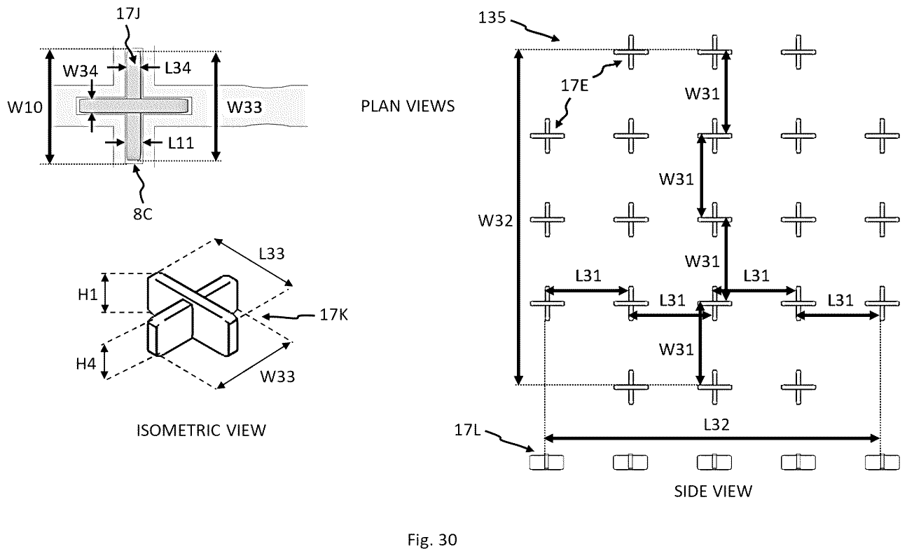

FIG. 30 illustrates plan, isometric and side views of male cross-connector length (L), width (W) and height (H) dimensions (17J, 17K) being slightly smaller than the corresponding female cross-connector dimensions (8C). Also shown is an array (135) of male cross-connectors showing their length (L) and width (W) separations intended for alignment with a respective array of female cross-connectors.

FIG. 31 illustrates plan views, top side of predominantly the length (L) dimensions for an Example 2 embodiment of a fabric-unit (1T).

Zoomed-in view 117 defines the dimensions and the location of the full female cross-connectors. Zoomed-in view 140 defines the location of the half female cross-connectors. Zoomed-in view 141 defines the HEC lip and channel dimensions and their location. Zoomed-in view 142 defines the convex bump and concave dimple dimensions and their location, as well as their width (W).

FIG. 32 illustrates plan views, top side of predominantly the width (W) dimensions for an Example 2 embodiment of a fabric-unit (1T).

Zoomed-in view 118 defines the dimensions and the location of the full female cross-connectors. Zoomed-in view 143 defines the location of the half female cross-connectors. Zoomed-in view 144 defines the HEC lip and channel dimensions and their location. Zoomed-in view 145 defines the convex bump and concave dimple dimensions and their location, as well as their length (L).

FIG. 33 illustrates profile views of a crossbar (150), outer cell wall (151) and HEC lip (152) showing their length (L) and height (H) and draft angle (A) dimensions for the fabric-unit Example 2 embodiment which is intended to be injection moulded. The length differences (E1, E2) between the top and bottom of each profile is calculated using draft angle (A) rather than being specified in FIG. 37. The profile drawings are not drawn to scale,

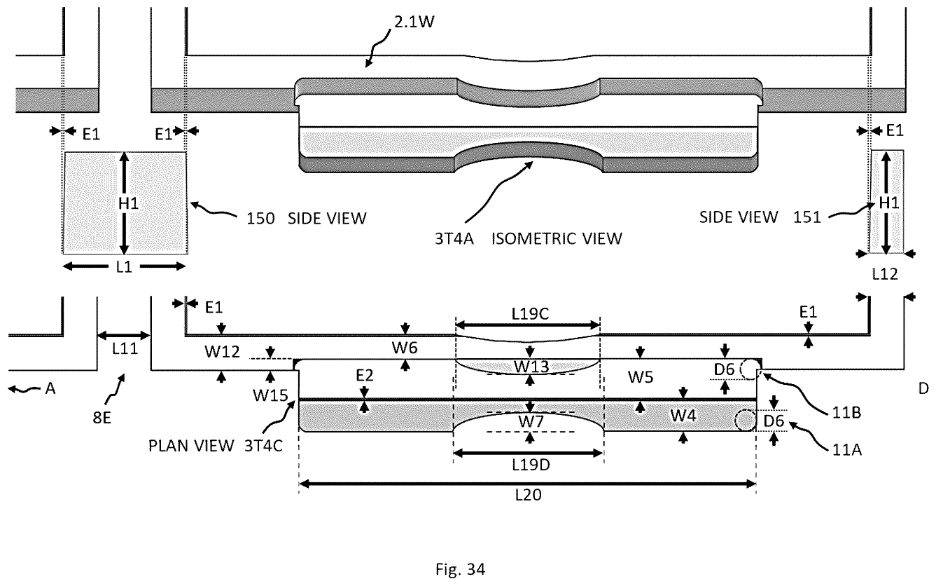

FIG. 34 illustrates a zoomed-in isometric view (3T4A) and plan view (3T4C) of a HEC specified for fabric-unit Example embodiment 2, showing their length (L) and width (W) dimensions. Also shown are the length (L) and height (H) dimensions of surrounding features such as a crossbar profile (150), outer cell wall profile (151) and half cross-connector (8E).

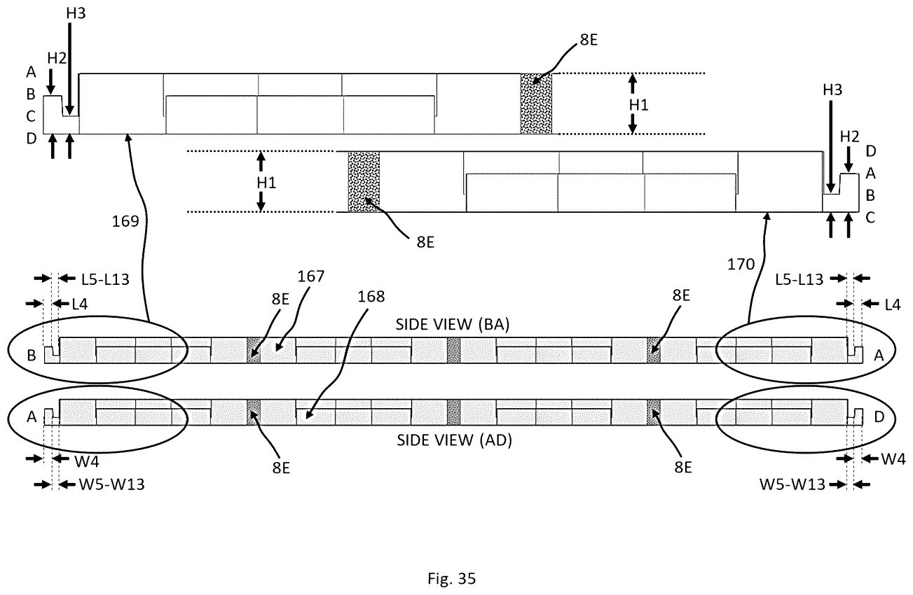

FIG. 35 illustrates a BA side view (167) and an adjacent AD side view (168) of a fabric-unit Example 2 embodiment, showing HEC length (L) and width (W) dimensions. Zoomed-in views of the HECs (169, 170) show their height (H) dimensions.

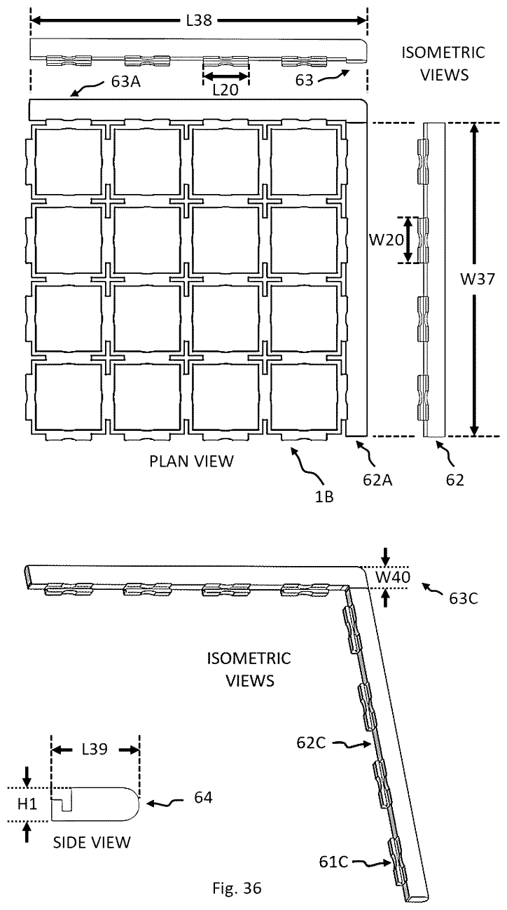

FIG. 36 illustrates plan, isometric and side views of the low-profile symmetrical edge panels most suited to the fabric-unit Example 2 embodiment. Length (L), width (W) and height (H) dimensions are shown.

FIG. 37 tabulates relevant dimensions that define the Example 1 and Example 2 fabric-unit embodiments and lists their representative values for a fabric-unit having a nominal length L_{F} and width W_{F} of 120 mm. The dimension definitions are shown in FIG. 22—36.

In this table, there is a common section (190A) for Example 1 and Example 2 embodiments and an Example 2 specific section (190C). Any Example dimensions included in section 190C (e.g., H₁) imply that similar dimensions (e.g., H₁) in 190A are Example 1 specific.

FIG. 38 tabulates relevant dimensions that define the Example 1 and Example 2 edge panels, game piece bases and accessories and lists their representative values for a fabric-unit having a nominal length L_{F} and width W_{F} of 120 mm. The definitions of each dimension are shown in FIG. 22—36.

In this table, there is a common section (191A) for Example 1 and Example 2 embodiments and an Example 2 specific section (191C). Any Example dimensions included in section 191C (e.g., H₁) imply that similar dimensions (e.g., H₁) in 190A are Example 1 specific.

FIG. 39 is a non-exhaustive list of important Dimensional Relationships DR1 to DR20 that define the design principles of the fabric-unit Example 1 and Example 2 embodiments.

FIG. 40 compares the contact surface areas (CSAs) for the HEC Example 1 embodiment and equivalently dimensioned jig-saw type edge connectors for representative 3×3 tile holders. The length (L) and width (W) dimensions are already much the same and have been normalised to that of the HEC Example 1 dimensions. The height (H) dimensions of the jig-saw type connector have been scaled upwards to equate to that of the HEC Example 1 dimensions. The respective wall-to-wall contact surface areas are analysed and calculated. The result is that CSA2 for the fabric-unit Example 1 HEC is 2.9 times greater than CSA1 for the scaled jig-saw type edge connector.

For a typical non-scaled jig-saw type edge connector, the ratio CSA2/CSA1 would be greater than 2.9 per edge connector. For a typical 3×3 tile grid as illustrated in FIG. 1A, the use of only one jig-saw type edge connector per side, instead of four HECs per side for the preferred fabric-unit embodiment of the present invention results in substantially greater bonding strength for the fabric-units of the present invention.

TABLE 1
List of Sheets, Figures and Reference Labels

| | | Ref. | |
|---|---|---|---|
| Sheet | FIG. | Label | Figure and Reference Label Descriptions |
| Reference Label | | | Label Suffixes T, B, L, W and H are reserved exclusively |
| first introduced | | | for Top, Bottom, Length, Width and Height respectively |
| 1/40 | FIG. 1A | | Game Board construction using 3x3 Tile Holders with |
| | | | Jig-Saw style Male-Female Edge Connectors |
| | | 201 | Single 3x3 Tile Holder with Jig-Saw style Male-Female |
| | | | Edge Connectors |
| | | 202 | Female Edge Connector, Jig-Saw style |
| | | 203 | Male Edge Connector, Jig-Saw style |
| | | 204 | Single Cell for holding a Game Tile |
| | | 205 | Cell Boundary for containing a Game Tile |
| | | 206 | Multi-cell Boundary for containing Game Tiles |
| | | 207 | Example Game Tile |
| | FIG. 1B | | Game Board construction using 2x2 Grid of Cells with |
| | | | Jig-Saw style Male-Female Edge Connectors |
| | | 301 | 2x2 Grid of Cells with Jig-Saw style Male-Female Edge |
| | | | Connectors |
| | | 302 | Jig-Saw style Female Edge Connector |
| | | 303 | Jig-Saw style Male Edge Connector |
| | | 304 | Single Cell within the 2x2 Grid |
| | | 305 | Optional Female Slot for mounting Game Board Walls |
| | FIG. 1C | | Game Board construction using single Tiles with Clips or |
| | | | Magnetic Ball type Edge Connectors |
| | | 401 | Dungeons and Dragons (D&D) Tile with Male Edge |
| | | | Connectors |
| | | 402 | Male Edge Connector for Dragonbite Clip |
| | | 403 | Cavity for Dragonbite Clip |
| | | 404 | Dragonbite Clips with Female Edge Connectors |
| | | 405 | Section of Game Board comprising 4 interconnected |
| | | | D&D Tiles |
| | | 411 | Optional Magnetic Base for each D&D Tile |
| | | 412 | Circular Holder for Magnetic Ball |
| | | 414 | Magnetic Ball with N & S Poles |
| | | 415 | Section of Game Board comprising 4 interconnected |
| | | | Magnetic D&D Tiles |
| 2/40 | FIG. 2 | | Fabric-unit—Top Side—Plan, Side and Isometric Views |
| | | 1 | Fabric-unit |
| | | 2 | Fabric-cells |
| | | 3 | Hermaphroditic Edge Connectors (HECs) |
| | | 8 | Female Cross-connectors |
| | | L | Length Dimension |
| | | W | Width Dimension |
| | | H | Height Dimension |
| 3/40 | FIG. 3A | | Fabric-unit with HECs Example 1—Top View |
| | | 1T | Fabric-unit—Top View with 16 HECs facing Up |
| | | 2T | Fabric-cells—Top View |
| | | 2.1 | Outer Fabric—cells around the perimeter of the |
| | | | Fabric-unit |
| | | 2.1L | Outer Walls—Length (L) direction |
| | | 2.2 | Inner Fabric-cells fully enclosed by Crossbars |
| | | 3T | 4 HECs per side—Top View |
| | | 3T1 | Left HEC—Top View |
| | | 3T2 | Mid-Left HEC—Top View |
| | | 3T3 | Mid-Right HEC—Top View |
| | | 3T4 | Right HEC—Top View |
| | | 3T3Z | Isometric Zoomed View of HEC 3T3—Top Side |
| | | 4E | HEC Lip |
| | | 4C | HEC Channel |
| | | 5C | Convex Bump section of HEC |
| | | 5D | Concave Dimple section of HEC |
| | | 6L | Crossbar—Length (L) direction |
| | | 7P | Circular Cutout Perimeter for Crossbars and Outer Walls |
| | | 7C | Circular Cutout of Crossbar |
| | | 7E | Circular Cutout of Outer Wall |
| | | 8C | Slots forming a Full Cross-Connector—Female at |
| | | | Intersecting Crossbars |
| | | 8E | Slots between adjacent HECs and in the outer edge of |
| | | | each Crossbar forming Half of a Cross-Connector— |
| | | | Female |
| | FIG. 3B | | Fabric-unit with HECs Example 1—Bottom View |
| | | 1B | Fabric-unit—Bottom View with 16 HECs facing Down |
| | | 2B | Fabric-cells—Bottom View |
| | | 2.1W | Outer Walls—Width (W) direction |
| | | 3B | 4 HECs per side—Bottom View |
| | | 3B1 | Left HEC—Bottom View |
| | | 3B2 | Mid-Left HEC—Bottom View |
| | | 3B3 | Mid-Right HEC—Bottom View |
| | | 3B4 | Right HEC—Bottom View |
| | | 6W | Crossbar—Width (W) Direction |
| 4/40 | FIG. 4A | | Fabric-unit with HEC Example 2—Top View |
| | FIG. 4B | | Fabric-unit with HEC Example 2—Bottom View |
| 5/40 | FIG. 5A | 3T4A | Isometric View of HEC 3T4—Example 2 |
| | | 2.1W | Outer Wall of Outer Fabric-cell 2.1 |
| | | 4R | Channel Recess inside Fabric-cell Outer Wall— |
| | | | Example 2 |
| | FIG. 5B | 3T4C | Plan View of HEC 3T4—Example 2 |
| | | 11A | HEC Lip Rounded Corners—Example 2 |
| | | 11B | HEC Channel Rounded Corners—Example 2 |
| 6/40 | FIG. 6A | | HEC Example 1 |
| | | 13A | Fabric-unit Side View with 4 HECs Up—Example 1 |
| | | 13C | Single HEC 3T1 Example 1—Side View |
| | FIG. 6B | | HEC Example 2 |
| | | 14A | Fabric-unit Side View with 4 HECs Up—Example 2 |
| | | 14C | Single HEC 3T1 Example 2—Side View |
| 7/40 | FIG. 7 | | Crossbar, Outer Cell Wall and HEC Lip Cross-Section |
| | | | Profile Views showing optional Draft Angle A° |
| | | 12A | Crossbar Profile View |
| | | 12C | Outer Cell Wall Profile View |
| | | 12D | HEC Lip Profile View |
| 8/40 | FIG. 8A | | Two Fabric-units Separated—Side View |
| | | 15A | Fabric-unit #1—Non-Inverted HEC Up—Side View |
| | | 15B | Fabric-unit #2—Inverted HEC Down—Side View |
| | FIG. 8B | | Two Fabric-units Joined—Side View |
| | | 16 | Lip 4E fitting inside Channel 4C forming a Connection |
| | | 4F | Tolerance Gaps nG (in L, W & H directions) |
| | | | between Lip and Channel Walls of Connected |
| | | | HECs—Refer to FIG. 39 |
| 9/40 | FIG. 9 | | Two Fabric-units Joined—HEC Example 2— |
| | | | with Male Cross-connectors—Isometric View |
| | | 18 | CB Up and AD Down HEC Edge Connectors Joined— |
| | | | HEC Example 2—Isometric View |
| | | 17 | Male Cross-Connectors, Isometric View |
| 10/40 | FIG. 10 | | 4 Fabric-unit 64 Fabric-Cell Game Board— |
| | | | HEC Example 1 |
| | | 19 | Four Fabric-units Connected—HEC Example 1—Plan |
| | | | View |
| | | 8F | No Cross-Connector in Centre for HEC Example 1 |
| | | 8G | No Cross-Connector at Centre Edge for HEC Example 1 |
| 11/40 | FIG. 11 | | 4 Fabric-unit 64 Fabric-Cell Game Board— |
| | | | HEC Example 2 |
| | | 20 | Four Fabric-units Connected—HEC Example 2—Plan |
| | | | View |
| | | 8J | Full Cross-Connector in Centre for HEC Example 2 |
| | | 8K | Half Cross-Connector at Centre Edge for HEC Example 2 |
| 12/40 | FIG. 12 | | 4 Fabric-unit Game Board with Tapered Edge Panels— |
| | | | HEC Example 1 |
| | | 30 | Straight Edge Panel with Connector Up— |
| | | | HEC Example 1 |
| | | 40 | Corner Edge Panel with Connector Up—HEC Example 1 |
| | | 50 | Straight Edge Panel with Connector Down— |
| | | | HEC Example 1 |
| | | 60 | Corner Edge Panel with Connector Down— |
| | | | HEC Example 1 |
| 13/40 | FIG. 13A | | Straight Edge Panel with Connector Up and Background |
| | | | Attachment Connectors |
| | | 30A | Straight Edge Panel with Connector Up— |
| | | | HEC Example 1—Top Side—Plan View |
| | | 30C | Straight Edge Panel with Connector Up— |
| | | | HEC Example 1—Top Side—Isometric View |
| | | 30D | Straight Edge Panel with Connector Up— |
| | | | HEC Example 1—Bottom Side—Isometric View |
| | | 30E | Straight Edge Panel with Connector Up— |
| | | | HEC Example 1—Side View |
| | | 31A | Background Attachment Button Connector—Side View |
| | | 31C | Background Attachment Button Connector— |
| | | | Bottom Side—Isometric View |
| | | 32A | Background Attachment Buttonhole Connector—Bottom |
| | | | Side—Isometric View |
| | | 61 | Fabric-unit compatible 3T2 and 3T3 edge connector— |
| | | | Example 1 |
| | | 61A | Fabric-unit compatible 3T1 and 3T4 edge connector— |
| | | | Example 1 |
| | FIG. 13B | | Male Button and Female Buttonhole Connectors |
| | | 31 | Button Connector—Isometric View |
| | | 32 | Buttonhole Connector—Isometric View |
| | | 31G | Button Connector—Side View |
| | | 31K | Buttonhole Connector—Side View |
| | FIG. 13C | | Corner Edge Panel with Connector Up and Background |
| | | | Attachment Connector |
| | | 40A | Corner Edge Panel with Connector Up—Top Side—Plan |
| | | | View |
| | | 40C | Corner Edge Panel with Connector Up—Top Side— |
| | | | Isometric View |
| | | 40D | Corner Edge Panel with Connector Up—Bottom Side— |
| | | | Isometric View |
| | | 40E | Corner Edge Panel with Connector Up—Bottom Side— |
| | | | Plan View |
| | | 31D | Background Attachment Button Connector—Top View |
| | | 31E | Background Attachment Button Connector—Bottom View |
| | | 31F | Background Attachment Button Connector—Top Side— |
| | | | Isometric View |
| | | 41A | Background Attachment Buttonhole Connector—Bottom |
| | | | Side—Isometric View |
| | | 41C | Background Attachment Buttonhole Connector—Bottom |
| | | | View |
| 14/40 | FIG. 14A | | Straight Edge Panel with Connector Down and |
| | | | Background Attachment Connectors |
| | | 50A | Straight Edge Panel with Connector Down— |
| | | | HEC Example 1—Top Side—Plan View |
| | | 50C | Straight Edge Panel with Connector Down— |
| | | | HEC Example 1—Top Side—Isometric View |
| | | 50D | Straight Edge Panel with Connector Down— |
| | | | HEC Example 1—Bottom Side—Isometric View |
| | | 50E | Straight Edge Panel with Connector Down— |
| | | | HEC Example 1—Side View |
| | | 32C | Background Attachment Buttonhole Connector—Bottom |
| | | | Side—Isometric View |
| | FIG. 14B | | Corner Edge Panel with Connector Down and |
| | | | Background Attachment Connector |
| | | 60A | Corner Edge Panel with Connector Down—Top Side— |
| | | | Plan View |
| | | 60C | Corner Edge Panel with Connector Down—Side— |
| | | | Isometric View |
| | | 60D | Corner Edge Panel with Connector Down— |
| | | | Bottom Side—Isometric View |
| | | 60E | Corner Edge Panel with Connector Down— |
| | | | Bottom Side—Plan View |
| 15/40 | FIG. 15A | | Simple Symmetric Edge Panels Connected to Fabric- |
| | | | unit—HEC Example 2—Plan View |
| | | 61C | Fabric-unit compatible edge connectors—Example 2 |
| | | 62 | Straight Edge Panel with Connector Up—HEC |
| | | | Example 2—Plan View |
| | | 62A | Straight Edge Panel with Connector Up Attached to |
| | | | Fabric-unit—HEC Example 2—Plan View |
| | | 63 | Corner Edge Panel with Connector Up—HEC Example |
| | | | 2—Plan View |
| | | 63A | Corner Edge Panel with Connector Up Attached to |
| | | | Fabric-unit—HEC Example 2—Plan View |
| | FIG. 15B | | Simple Symmetric Edge Panels—HEC Example 2— |
| | | | Isometric View |
| | | 62C | Straight Edge Panel with Connector Up—HEC |
| | | | Example 2—Isometric View |
| | | 63C | Corner Edge Panel with Connector Up—HEC |
| | | | Example 2—Isometric View |
| | FIG. 15C | | Simple Symmetric Edge Panel—HEC Example |
| | | | 2—Side View |
| | | 64 | Simple Symmetric Rounded Edge-Panel— |
| | | | HEC Example 2—Side View |
| 16/40 | FIG. 16 | | Zoomed-in Cut-out of a Fabric-unit 1T showing Circular |
| | | | Indents (7C, 7E), 3D Game Piece and Base Options |
| | | 97 | 3D Game Piece example—Isometric View |
| | | 98 | Circular Base of 3D Game Piece—Isometric View |
| | | 99 | Circular Base—Isometric View |
| | | 100 | Circular Base with Text Description—Isometric View |
| | | 101 | Square Base—Isometric View |
| | | 102 | Square Base with Text Description—Isometric View |
| 17/40 | FIG. 17 | | Game Board comprising Semi-Transparent Fabric-units, |
| | | | Edge Panels and Background Graphic Layer—HEC |
| | | | Example 2 |
| | | 66 | Semi-Transparent 24 Fabric-unit, 384 Fabric-Cell Game |
| | | | Board with Edge Panels—HEC Example 2—Illustrative |
| | | 67 | Semi-Transparent Crossbars |
| | | 68 | Background Graphic Layer |
| 18/40 | FIG. 18A | | Game Board (66) comprising Semi-Transparent Fabric- |
| | | | units and Edge Panels—Top View—Illustrative |
| | FIG. 18B | | Background Graphic Layer (68) with attached Connector |
| | | | options (17A and 31L) |
| | | 17A | Male Cross-connectors affixed to Background Graphic |
| | | | Layer |
| | | 31L | Button Connectors affixed to Background Graphic Layer |
| | FIG. 18C | | Game Board (66A) comprising Semi-Transparent Fabric- |
| | | | units and Edge Panels—Bottom View—Illustrative |
| | | 8E | Fabric-units' Female Cross-connectors |
| | | 32E | Edge Panel Female Buttonhole Connectors |
| | FIG. 18D | | Completed Game Board comprising Semi-Transparent |
| | | | Fabric-units, Edge Panels and Background Graphic |
| | | | Layer—HEC Example 2—Top View Illustrative |
| 19/40 | FIG. 19 | | 4 Fabric-unit Section of Game Board with a 3D Game |
| | | | Piece and Plug-in Accessories |
| | | 80 | 4 Fabric-unit Section of Game Board |
| | | 88 | Building Accessory Affixed to Game Board |
| | | 89 | Game Board Building Accessory revealing attached Male |
| | | | Cross-Connectors (17L)—Bottom Side—Isometric View |
| | | 90 | Game Board Building Accessory—Side View |
| | | 91 | Game Board Building Accessory—Bottom View |
| | | 92 | Straight Wall Accessory to be Affixed to Game Board— |
| | | | Isometric View |
| | | 93 | Game Board Straight Wall Accessory—Top Side— |
| | | | Isometric View |
| | | 94 | Game Board Straight Wall Accessory—Top View |
| | | 95 | Game Board Corner Wall Accessory—Top Side— |
| | | | Isometric View |
| | | 96 | Game Board Corner Wall Accessory—Top View |
| | | 97 | 3D Game Piece with Circular Base—Isometric View |
| | | 97A | 3D Game Piece with Circular Base placed in Fabric- |
| | | | cell—Isometric View |
| | | 17D | Male Cross-connector—Side View |
| | | 17E | Male Cross-connector—Top View |
| | | 17F | Male Cross-connector—Isometric View |
| | | 17G | Male Cross-connector fitted to Female Cross- |
| | | | connector—Isometric View |
| | | 17J | Male Cross-connector Affixed to Game Board Straight |
| | | | Wall Accessory—Top Side—Isometric View |
| | | 17K | Male Cross-connector Affixed to Game Board Straight |
| | | | Wall Accessory—Top of Fabric-unit—Isometric View |
| | | 17L | Male Cross-connector Affixed to Game Board Building |
| | | | Accessory—Bottom Side—Isometric View |
| | | 17M | Male Cross-connector Affixed to Game Board Building |
| | | | Accessory—Side View |
| 20/40 | FIG. 20 | | Buttonhole and Button Connector showing Adhesive |
| | | | Sticker option |
| | | 32G | Buttonhole Connector—Side View |
| | | 32J | Buttonhole Connector—Bottom Side, Isometric View |
| | | 31M | Button Connector—Side View |
| | | 31N | Buttonhole Connector—Top Side—Isometric View |
| | | 33 | Adhesive Sticker for Attaching to Background Graphic |
| | | | Layer |
| | | 34 | Adhesive Sticker—Glue Layer |
| | | 35 | Removeable Waxed Paper or Plastic Cover |
| 21/40 | FIG. 21 | | Male Cross-Connector Array |
| | | 110A | Male Cross-Connector Array—Top Side—Plan View |
| | | 112 | Plastic Breakaway Holder |
| | | 114 | Thin Plastic Connection 1 |
| | | 115 | Thin Plastic Connection 2 |
| | | 110C | Male Cross-Connector Array—Top Side—Isometric View |
| | | 110D | Male Cross-Connector Array—Bottom Side—Isometric |
| | | | View |
| | | 110E | Male Cross-Connector Array—Side View |
| 22/40 | FIG. 22 | | Fabric-unit Length Dimensions—HEC Example 1 |
| | | 117 | Female Cross-Connector 8C—Length Dimensions |
| | | 120 | Female Cross-Connector 8E—Length Dimension— |
| | | | HEC Example 1 |
| | | 121 | HEC 3T1—Length Dimensions—HEC Example 1 |
| | | 122 | HEC 3T2 and 3T3—Length and Width Dimensions— |
| | | | HEC Example 1 |
| 23/40 | FIG. 23 | | Fabric-unit Width Dimensions—HEC Example 1 |
| | | 118 | Female Cross-Connector 8C—Width Dimensions |
| | | 123 | Female Cross-Connector 8E—Width Dimension— |
| | | | HEC Example 1 |
| | | 124 | HEC 3T1—Width Dimensions—HEC Example 1 |
| | | 125 | HEC 3T2 and 3T3—Width and Length Dimensions— |
| | | | HEC Example 1 |
| 24/40 | FIG. 24 | | Fabric-unit Hermaphroditic Edge Connector Dimensions |
| | | | (Side View)—HEC Example 1 |
| | | 127 | HEC Edge Connector Side View (BA)—Length |
| | | | Dimensions—HEC Example 1 |
| | | 128 | HEC Edge Connector Side View (AD)—Width |
| | | | Dimensions—HEC Example 1 |
| 25/40 | FIG. 25A | | Fabric-unit HEC Length and Height Dimensions (Side |
| | | | View)—HEC Example 1 |
| | | 129 | HEC 3T1 Example 1—Length and Height Dimensions |
| | FIG. 25B | | Fabric-unit HEC Length and Height Dimensions (Side |
| | | | View)—HEC Example 2 |
| | | 133 | HEC 3T1 Example 2—Length and Height Dimensions |
| 26/40 | FIG. 26 | | Male “Button” and Female “Buttonhole” Connector |
| | | | Dimensions |
| | | 32G | Female (F) “Buttonhole” Connector Dimensions—Side |
| | | | View |
| | | 31M | Male (M) “Button” Connector Dimensions—Side View |
| | | 34 | Adhesive Sticker Glue Layer, thickness T2 |
| | | 35 | Removable Waxed Paper or Plastic Cover, thickness T3 |
| 27/40 | FIG. 27 | | Straight Edge Panel Dimensions—HEC Example 1 |
| | | 30F | Straight Edge Panel with Connector Up Dimensions— |
| | | | HEC Example 1—Side View |
| | | 30G | Straight Edge Panel with Connector Up Dimensions— |
| | | | HEC Example 1—Bottom View |
| | | 32K | Female “Buttonhole” Connector Location 1 |
| | | | Dimensions—Bottom View |
| | | 50F | Straight Edge Panel with Connector Down Dimensions— |
| | | | HEC Example 1—Side View |
| | | 50G | Straight Edge Panel with Connector Down Dimensions— |
| | | | HEC Example 1—Bottom View |
| | | 32L | Female “Buttonhole” Connector Location 2 Dimensions— |
| | | | Bottom View |
| 28/40 | FIG. 28 | | Corner Edge Panel Dimensions—HEC Example 1 |
| | | 40F | Corner Edge Panel with Connector Up Dimensions— |
| | | | HEC Example 1—Side View |
| | | 40G | Corner Edge Panel with Connector Up Dimensions— |
| | | | HEC Example 1—Bottom View |
| | | 32M | Female “Buttonhole” Connector Location 3 Dimensions— |
| | | | Bottom View |
| | | 60F | Corner Edge Panel with Connector Down Dimensions— |
| | | | HEC Example 1—Side View |
| | | 60G | Corner Edge Panel with Connector Down Dimensions— |
| | | | HEC Example 1—Bottom View |
| | | 32N | Female “Buttonhole” Connector Location 4 Dimensions— |
| | | | Bottom View |
| 29/40 | FIG. 29 | | Game Piece Base Dimensions |
| | | 100A | Circular Game Piece Base Dimensions—Top View |
| | | 100B | Circular Game Piece Base Dimensions—Side View |
| | | 102A | Square Game Piece Base Dimensions—Top View |
| | | 102B | Square Game Piece Base Dimensions—Side View |
| 30/40 | FIG. 30 | | Male Cross-Connector Dimensions and Array Spacing |
| | | 17J | Male Cross-Connector Length and Width Dimensions— |
| | | | Top Side—Plan View |
| | | 17K | Male Cross-Connector Length, Width and Height |
| | | | Dimensions—Top Side—Isometric View |
| | | 17L | Male Cross-Connector—Side View |
| | | 135 | Male Cross-Connector Length and Width Spacings in an |
| | | | Array |
| 31/40 | FIG. 31 | | Fabric-unit Length Dimensions—HEC Example 2 |
| | | 140 | Female Cross-Connector 8E—Length Dimension— |
| | | | HEC Example 2 |
| | | 141 | HEC 3T1—Length Dimensions—HEC Example 2 |
| | | 142 | HEC 3T2 and 3T3—Length and Width Dimensions— |
| | | | HEC Example 2 |
| 32/40 | FIG. 32 | | Fabric-unit Width Dimensions—HEC Example 2 |
| | | 143 | Female Cross-Connector 8E—Width Dimension— |
| | | | HEC Example 2 |
| | | 144 | HEC 3T1—Width Dimensions—HEC Example 2 |
| | | 145 | HEC 3T2 and 3T3—Width and Length Dimensions— |
| | | | HEC Example 2 |
| 33/40 | FIG. 33 | | Draft-Angle added to Crossbars and Edge Connectors for |
| | | | Injection Moulded Manufacturing |
| | | 150 | Centre Crossbar with Draft-Angles and Dimensions |
| | | 151 | Outer Cell Wall with Draft-Angle and Dimensions |
| | | 152 | HEC Lip—Example 2 with Draft-Angle and Dimensions |
| 34/40 | FIG. 34 | | Fabric-unit and Hermaphroditic Edge Connector |
| | | | Dimensions—HEC Example 2 |
| | | 150 | Centre Crossbar Profile—Length and Height Dimensions |
| | | 151 | Outer Cell Wall Profile—Length and Height Dimensions |
| | | 3T4A | HEC 3T4—Example 2—Isometric View |
| | | 3T4C | HEC 3T4—Example 2—Plan View—Length and Width |
| | | | Dimensions |
| 35/40 | FIG. 35 | | Hermaphroditic Edge Connector Dimensions |
| | | | (Side View)—HEC Example 2 |
| | | 167 | HEC Edge Connector Side View (BA)—Length |
| | | | Dimensions—HEC Example 2 |
| | | 168 | HEC Edge Connector Side View (AD)—Width |
| | | | Dimensions—HEC Example 2 |
| | | 169 | B-Side of Drawing 167—Height Dimensions— |
| | | | HEC Example 2 |
| | | 170 | A-Side of Drawing 167—Height Dimensions— |
| | | | HEC Example 2 |
| 36/40 | FIG. 36 | | Simple Symmetric Edge Panel Dimensions— |
| | | | HEC Example 2 |
| | | 62 | Straight Edge Panel—Width Dimension— |
| | | | HEC Example 2—Isometric View |
| | | 63 | Corner Edge Panel—Length Dimension— |
| | | | HEC Example 2—Isometric View |
| | | 63C | Corner Edge Panel—Width Dimension— |
| | | | HEC Example 2—Isometric View |
| | | 64 | Symmetric Rounded Edge Panel—Length and Height |
| | | | Dimensions—HEC Example 2—Side View |
| 37/40 | FIG. 37 | | Representative Dimensions for L_{F} = 120 mm Fabric-unit |
| | | 190A | Fabric-unit HEC Examples 1 and 2—Common Table of |
| | | | Representative Dimensions |
| | | 190C | Fabric-unit HEC Example 2—Variations in |
| | | | Representative Dimensions |
| 38/40 | FIG. 38 | | Representative Dimensions for 120 mm Fabric-unit Edge |
| | | | Panels, Game Piece Bases and Game Accessories |
| | | 191A | Fabric-unit HEC Examples 1 and 2—Common Table of |
| | | | Representative Dimensions |
| | | 191C | Fabric-unit Accessories HEC Example 2—Variations in |
| | | | Representative Dimensions |
| 39/40 | FIG. 39 | | Fabric-unit Dimensional Relationships (DR) |
| | | DR1 | Edge to Edge Dimensions = Same for all 4 sides |
| | | DR2 | Nominal Fabric-unit Length and Width = 4 x Nominal |
| | | | Cell Length and Width respectively |
| | | DR3 | Edge to Edge Length = Sum of 2x HECs, plus |
| | | | 3x Crossbars and 4x Cell Inner Length Dimensions |
| | | DR4 | Edge to Edge Width = Sum of 2x HECs, plus |
| | | | 3x Crossbars and 4x Cell Inner Width Dimensions |
| | | DR5 | HEC Channel Recess inside Outer Cell Outer Wall |
| | | | (Length Direction) |
| | | DR6 | HEC Channel Recess inside Outer Cell Outer Wall |
| | | | (Width Direction) |
| | | DR7 | Cell Outer Length Dimension = Sum of Cell Inner |
| | | | Dimension and Crossbar Dimension |
| | | DR8 | Cell Outer Width Dimension = Sum of Cell Inner |
| | | | Dimension and Crossbar Dimension |
| | | DR9 | HEC Long-side = Cell Outer Dimension less Female |
| | | | Cross-connector Long-side (Length Direction) |
| | | DR10 | HEC Long-side = Cell Outer Dimension less Female |
| | | | Cross-connector Long-side (Width Direction) |
| | | DR11 | HEC Short side = Lip plus Channel plus Outer Cell Outer |
| | | | Wall Dimensions (Length Direction) |
| | | DR12 | HEC Short side = Lip plus Channel plus Outer Cell Outer |
| | | | Wall Dimensions (Width Direction) |
| | | DR13 | Crossbar Short-side = Sum of 2x Cross-Connector wall |
| | | | Dimensions plus Cross-Connector Short-side |
| | | | (Length Direction) |
| | | DR14 | Crossbar Short-side = Sum of 2x Cross-Connector wall |
| | | | Dimensions plus Cross-Connector Short-side |
| | | | (Width Direction) |
| | | DR15 | Edge to Edge Length = Sum of 4x Cell Outer-Length |
| | | | plus 2x HEC Lip Short-side plus Gap (Length Direction) |
| | | | in Terms of G = 0.1 mm |
| | | DR16 | Edge to Edge Width = Sum of 4x Cell Outer-Width |
| | | | plus 2x HEC Lip Short-side plus Gap (Width Direction) |
| | | | in Terms of G = 0.1 mm |
| | | DR17 | Average HEC Connection Gap (Length/Width Directions) |
| | | | for Example 1 Fabric-Unit in Terms of G = 0.1 mm |
| | | DR18 | Average HEC Connection Gap (Length/Width Directions) |
| | | | for Example 2 Fabric-Unit in Terms of G = 0.1 mm |
| | | DR19 | HEC Connection Gap (Height Direction) for Example 1 |
| | | | Fabric-Unit in Terms of G = 0.1 mm |
| | | DR20 | HEC Connection Gap (Height Direction) for Example 2 |
| | | | Fabric-Unit in Terms of G = 0.1 mm |
| 40/40 | FIG. 40 | | Comparative Contact Surface Areas for HEC Example 1 |
| | | | and Equivalent Dimensioned Jig-Saw Type Edge |
| | | | Connectors for Representative Tile Holders |
| | | 195A | HEC Example 1 Contact Surfaces 1—L&W Dimensions |
| | | 195B | HEC Example 1 Contact Surfaces 2—L&W Dimensions |
| | | 196A | HEC Example 1 Contact Surfaces 3—L&H Dimensions |
| | | 196B | HEC Example 1 Contact Surfaces 4—L&H Dimensions |
| | | 197 | HEC Example 1 Contact Surfaces 5—L&H Dimensions |
| | | 211 | Edge of Representative Tile Holder—Isometric View |
| | | 212 | Female Edge Connector, Jig-Saw style—Isometric View |
| | | 213A | Male Edge Connector, Jig-Saw style—Isometric View |
| | | 213B | Male Edge Connector, Jig-Saw style—Plan View |
| | | 213C | Male Edge Connector, Jig-Saw style—Side View |
| | | 215A | Cell Boundary for a Game Tile—Isometric View |
| | | 215B | Cell Boundary for a Game Tile—Plan View |
| | | 215C | Cell Boundary for a Game Tile—Side View |
| | | 216A | Tile Holder Contact Surfaces 1—W&H Dimensions |
| | | 216B | Tile Holder Contact Surfaces 2—W&H Dimensions |
| | | 217 | Tile Holder Contact Surfaces 3—L&H Dimensions |
| | | 218A | Tile Holder Contact Surfaces 4—W&H Dimensions |
| | | 218B | Tile Holder Contact Surfaces 5—W&H Dimensions |
| | | 220 | Calculations of Edge Connector Contact Surface Areas |

1. A modular fabric-unit (1) for constructing self-supporting game boards of different types, sizes and shapes, comprising:
(a) an array of 3-dimensional square fabric-cells (2) all having equal dimensions for locating game tiles, 3D game pieces or game board accessories;
(b) crossbars (6L and 6W) running the length and width respectively of the fabric-unit;
(c) outer walls (2.1L and 2.1W) of outer fabric-cells (2.1); whereby
(d) the crossbars (6L and 6W) and outer walls (2.1L and 2.1W) define the dimensions of the fabric-cells and provide the strength needed for constructing a self-supporting game board; and
(e) a plurality of hermaphroditic edge connectors (3) attached to each side of the fabric-unit;
(f) said hermaphroditic edge-connectors each containing a lip (4E) and channel (4C) structure; whereby
(g) the lip of each non-inverted fabric-unit (1T) edge-connector fits into the corresponding edge-connector channel of an inverted fabric-unit (1B) to form a tight and self-supporting connection between adjacent fabric-units (16).

2. The fabric-unit of claim 1, wherein the hermaphroditic edge connectors have matching convex bumps (5C) and concave dimples (5D) on the channel walls and lips respectively for increasing the contact surface area and connection strength, and for aiding the alignment of adjacent fabric-units when being joined, and for preventing sideways slippage of connected fabric-units when joined.

3. The fabric-unit of claim 1, wherein the hermaphroditic edge connector channel (4C) contains a channel recess (4R) in the outer wall (2.1L and 2.1W) of an outer fabric-cell (2.1) for aiding the alignment of adjacent fabric-units when being joined and for preventing sideways slippage of connected fabric-units when joined.

4. The fabric-unit of claim 1, wherein slots that form female cross-connectors (8C) are included for mounting game board accessories that are fitted with compatible male cross-connectors (17), said female cross-connectors located at the intersection of crossbars (6L and 6W); whereby the slots pass through from the top side to the bottom side of the fabric-unit, and are limited in size to retain sufficient crossbar strength needed for constructing a self-supporting game board.

5. The fabric-unit of claim 1, wherein slots that form half of a female cross-connector (8E) for mounting game board accessories are included between adjacent hermaphroditic edge connectors and at the outer edge of crossbars (6L and 6W); whereby the slots pass through from the top side to the bottom side of the fabric-unit, and are limited in size to retain sufficient hermaphroditic edge connector and crossbar strength needed for constructing a self-supporting game board, and when non-inverted and inverted fabric-units are connected (18), the two half female cross-connectors form a full female cross-connector to which a compatible male cross-connector 17 can be fitted.

6. The fabric-unit of claim 1, wherein the four inner walls that define each fabric-cell each contain a small circular indent (7C and 7E) in the centre of each wall to support a circular game piece base (99, 100) with a diameter that is slightly larger than the largest square game piece base (101, 102) for which the fabric-cell is dimensioned to support.

7. The fabric-unit of claim 1, wherein the total fabric-cell area per fabric-unit is maximised while retaining sufficient crossbar, outer wall and hermaphroditic edge connector strength needed for constructing a self-supporting game board.

8. The fabric-unit of claim 1, wherein a background graphic layer (68) is selected for each game board with a plurality of compatible male cross-connectors (17, 17A) affixed by glue or other means to the background graphic layer, said male cross-connectors then fitted to female cross-connectors (8, 8C, 8E, 8L) that are suitably distributed across all fabric-units for increasing the self-supporting strength of the game board, with said background graphic layer also providing a base for holding game tiles and 3D game pieces.

9. The fabric-unit of claim 1, wherein the crossbars, outer walls and hermaphroditic edge connectors comprise a material that has high optical transparency to visible wavelengths of light (67).

10. The fabric-unit of claim 1, wherein some or all fabric-unit crossbars (12A), outer cell walls (12C) and hermaphroditic edge connector lips (12D) are slightly tapered with draft angle (A°) from bottom to top to better support low-cost, high-volume manufacturing using injection moulding techniques.

11. The fabric-unit of claim 1, wherein edge panels (30, 40, 50, 60, 62, 63) are connected for constructing a cosmetic perimeter.
